(19) United States
(12) Patent Application Publication
(10) Pub. No.: US 2008/0220140 A1
(43) Pub. Date: Sep. 11, 2008

(54) USE OF PROPENYLPHENYL GLYCOSIDES FOR ENHANCING SWEET SENSORY IMPRESSIONS

(75) Inventors: Jakob Ley, Holzminden (DE); Jan Looft, Holzminden (DE); Susanne Paetz, Hoexter (DE)

Correspondence Address: CONNOLLY BOVE LODGE & HUTZ, LLP, P O BOX 2207, WILMINGTON, DE, 19899, US

(73) Assignee: SYMRISE GmbH & Co. KG, Holzminden (DE)

(21) Appl. No.: 12/020,301

(22) Filed: Jan. 25, 2008

Related U.S. Application Data
(60) Provisional application No. 60/886,548, filed on Jan. 25, 2007.

(51) Int. Cl. A23L 1/22

(52) U.S. Cl. 426/538

(57) ABSTRACT

The invention relates to the use of a propenylphenyl glycoside of formula (I)

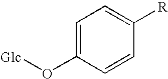

wherein
R is (1E)-prop-1-enyl, (1Z)-prop-1-enyl or prop-2-enyl; and
Glc is an α- or β-glycosidically bonded mono- or oligo-saccharide,
   for enhancing the sweet taste of a sweet-tasting substance or the sweet odour impression of a flavouring that produces a sweet odour impression.

### RELATED APPLICATIONS

This application claims benefit to U.S. Provisional application 60/886,548 filed Jan 25, 2007.

The invention relates primarily to the use of specific propenylphenyl glycosides for enhancing the sweet taste of sweet-tasting substances or the sweet odour impression of flavourings that produce a sweet odour impression. The invention accordingly relates primarily to said substances as sweetness enhancers. The invention relates also to specific preparations that comprise an effective content of said propenylphenyl glycosides and to methods for enhancing the sweet taste of a sweet-tasting substance or the sweet odour impression of a flavouring that produces a sweet odour impression.

Foods (including beverages) or enjoyment foods (including beverages and entities corresponding to the German term “Genussmittel” as defined in Duden “Das groβe Wöder deutschen Sprache” in 6 Bd., Mannheim 1979) with a high sugar content (especially sucrose (=saccharose), lactose, glucose or fructose or mixtures thereof) are generally greatly preferred by consumers because of the sweetness. On the other hand, it is generally known that a high content of readily metabolisable carbohydrates causes a pronounced increase in the blood sugar level, leads to the formation of fatty deposits and can ultimately lead to health problems, such as overweight, obesity, insulin resistance, adult onset diabetes and the secondary complications thereof. A further factor is that many of the above-mentioned carbohydrates can additionally impair dental health, because they are decomposed by specific types of bacteria in the oral cavity to lactic acid, for example, and can attack the enamel of the milk or adult teeth (caries).

It has therefore long been an aim to reduce the sugar content of foods and/or enjoyment foods (both as defined above) to the level that is absolutely necessary or below. A corresponding measure consists in the use of sweeteners: these are chemically uniform substances which themselves have no or only a very low calorific value and at the same time produce a strong sweet taste impression; the substances are generally non-cariogenic (an overview is to be found, for example, in Journal of the American Dietetic Association 2004, 104 (2), 255-275). Although some of the so-called bulk sweeteners such as sorbitol, mannitol or other sugar alcohols are excellent sweeteners and can also partly replace the other food-related properties of sugars, they cause osmotically-related digestive problems in some of the population if they are eaten too frequently. The non-nutritive high-intensity sweeteners are highly suitable for imparting sweetness to foods because of their low use concentration, but they often exhibit taste problems owing to different time/intensity profiles as compared with sugar (e.g. sucralose, stevioside, cyclamate), a bitter and/or astringent after-taste (e.g. acesulfame K, saccharin), pronounced additional flavour impressions (e.g. glycyrrhyzic acid ammonium salt). Some of the sweeteners are not particularly stable to heat (e.g. thaumatin, brazzein, monellin), are not stable in all applications (e.g. aspartame) and in some cases have a very long-lasting sweet action (strong sweet after-taste, e.g. saccharin, sucralose).

An improvement in the taste properties, in particular the after-taste problem, of non-nutritive high-intensity sweeteners can be achieved by the use of tannic acid, for example as described in WO 98/20753, or phenolic acids, as in U.S. Pat. No. 3,924,017. However, such substances are not particularly stable in applications because of their catechol units.

Another possibility—without using non-nutritive sweeteners—consists in lowering the sugar content of foods and/or enjoyment foods (both as defined above) and adding sensorially weak or imperceptible substances which enhance the sweetness directly or indirectly, as described, for example, in WO 2005/041684. However, the substances described in WO 2005/041684 are expressly of non-natural origin and are accordingly harder to assess from a toxicological point of view than substances of natural origin, in particular when the latter occur in foods or enjoyment foods or come from raw materials for obtaining foods or enjoyment foods. EP 1 291 342 describes such substances of natural origin (pyridinium betaines); however, they do not selectively influence the sweet taste, but also other taste qualities, such as umami or saltiness. In addition, the disclosed substances can be purified only with a high outlay.

PCT/EP 2006/06433 recommends the use of hesperetin, and in U.S. 60/784,444 and the documents based thereon (Symrise), phloretin is recommended as an enhancer of the sweet taste of reduced-sugar preparations for nutrition or enjoyment. However, an occasional disadvantage of the use of hesperetin and phloretin is the comparatively weak sweetness enhancement in foods and enjoyment foods (both as defined above) containing high proportions of proteins, in particular denatured proteins, or polysaccharides, such as, for example, yoghurt products.

It is therefore desirable to find substances which, in low concentrations, effectively enhance sweet taste impressions of sweet substances, preferably the sweet taste impression of reduced-sugar foods and enjoyment foods (both as defined above), in particular of reduced-sugar foods and enjoyment foods (both as defined above) containing a high proportion of proteins, in particular denatured proteins, or polysaccharides, without adversely affecting the rest of the flavour profile. It is likewise desirable to find substances which, in low concentrations, effectively enhance sweet odour impressions of flavourings that produce a sweet odour impression.

The primary object of the present invention was to find substances which (a) are suitable for selectively enhancing the sweet taste of a sweet-tasting substance and/or the sweet odour impression of a flavouring that produces a sweet odour impression, preferably without adversely affecting the rest of the flavour profile, (b) are widely usable even in preparations containing a high proportion of proteins, in particular denatured proteins, or polysaccharides, and preferably (c) occur naturally, preferably in food and/or spice plants or extracts prepared therefrom for their preparation or are formed in the preparation of foods or enjoyment foods (both as defined above).

According to a first aspect of the present invention, the stated object is achieved by the use of

a propenylphenyl glycoside of formula (I)

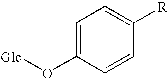

wherein
R is (1E)-prop-1-enyl, (1Z)-prop-1-enyl or prop-2-enyl and
Glc is an α- or β-glycosidically bonded mono- or oligo-saccharide, or

of a mixture comprising or consisting of two or more different propenylphenyl glycosides of formula (I) wherein R and Glc in each case have one of the meanings given above,

for enhancing the sweet taste of a sweet-tasting substance or the sweet odour impression of a flavouring that produces a sweet odour impression.

α- or β-glycosidically bonded mono- or oligo-saccharides within the scope of the invention are monosaccharides or di-, tri- or tetra-saccharides, that is to say saccharides built up of 2, 3 or 4 monosaccharide units via oxygen bridges, wherein the monosaccharides or monosaccharide units are in each case preferably selected, and where 2 or more monosaccharide units are in each case preferably selected and where 2 or more monosaccharide units are present, are selected independently of one another, from the D- and L-isomers of allose, altrose, gulose, mannose, glucose, idose, galactose, talose, psicose, sorbose, fructose, tagatose, rhamnose, fucose, xylose, lyxose, ribose, ribulose, xylulose, tertrulose, arabinose, erythritose, threose, glyceraldehyde, 2-amino-2-deoxy-glucose, 2-amino-2-deoxy-mannose, 2-amino-2-deoxy-galactose, 2-acetylamino-2-deoxy-glucose, 2-acetylamino-2-deoxy-mannose, 2-acetylamino-2-deoxy-galactose, apiose, glucuronic acid, galacturonic acid, glucuronic acid methyl ester, galacturonic acid methyl ester, galactosamine sulfate or glucosamine sulfate, wherein the individual monosaccharides or monosaccharide units can be present in the form of open-chained or cyclic pyranose or furanose isomers and the linking of the monosaccharide or of a monosaccharide unit takes place via its anomeric centre, α- or β-glycosidicaliy, to the phenolic oxygen atom of the aglycone.

Preferred α- or β-glycosidically bonded oligosaccharides are mono- or di-saccharides, that is to say monosaccharides or oligosaccharides built up from 2 monosaccharide units via oxygen bridges, wherein the monosaccharides or monosaccharide units are in each case selected (independently of one another) from the D-isomers of mannose, glucose, galactose, fructose, rhamnose, xylose, lyxose, ribose, arabinose, apiose, wherein the individual monosaccharides or monosaccharide units are present in the form of cyclic pyranose or furanose isomers and the linking of the monosaccharide or of one of the monosaccharide units takes place via its anomeric centre, α- or β-glycosidically, to the phenolic oxygen atom of the aglycone.

Particularly preferred α- or β-glycosidically bonded oligosaccharides are D-gluco-pyranose, D-galactopyranose, D-mannopyranose, maltobiose, cellobiose, lactose, primeverose, neohesperidose, rutinose or acuminose, which are bonded α- or β-glycosidically to the phenolic oxygen atom of the aglycone.

Particular preference is given to a use according to the invention wherein in formula (I)
Glc is an α- or β-glycosidically bonded mono- or oligo-saccharide selected from the group consisting of D-glucopyranose, D-galactopyranose, D-mannopyranose, maltobiose, cellobiose, lactose, primeverose, neohesperidose and rutinose.

Very particular preference is given to the use of propenylphenyl glucosides selected from the group consisting of the α- or β-anomers, particularly preferably the β-anomers, of
1-O-[4-(propen-2-enyl)phenyl]-D-glucopyranoside (chavicol glucoside, compound 1),
1-O-[4-(propen-2-enyl)phenyl]-6-O-β-D-apiofuranosyl-D-glucopyranoside (furcatin, compound 2),
1′-O-[4-(propen-2-enyl)phenyl]-6-O-β-D-rutinoside (compound 3) and
1′-O-[4-(propen-2-enyl)phenyl]-O-β-D-xylopyranosyl-(1-6)-β-D-glucopyranoside (p-allylphenylprimeveroside, miyaginin, compound 4).

It goes without saying that the use of a mixture comprising or consisting of 2 or more of the above-mentioned compounds 1, 2, 3 and/or 4 is also particularly preferred.

The preferred compounds 1, 2, 3 and 4 are shown again in the following diagram for clarification (the numbering scheme is shown in compound 1):

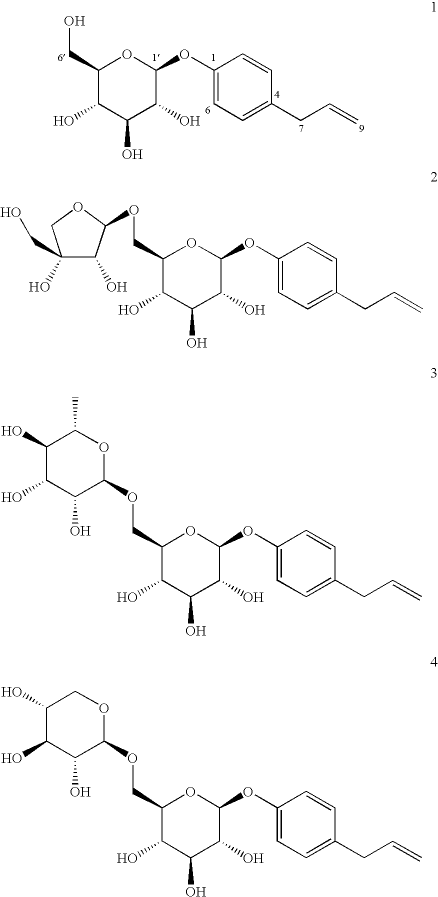

It should be noted that the propenylphenyl glycosides of formula (I) to be used according to the invention (in particular in an embodiment described as being preferred) are generally not used in an amount or administration form in which their intrinsic sweetness, or the intrinsic sweetness of the mono- or oligo-saccharides optionally obtained therefrom by decomposition, is sensorially perceptible. With regard to information on preferred use concentrations, see below.

The above-mentioned substances and substance mixtures to be used according to the invention (in particular the compounds and mixtures described hereinbefore as being preferred) are preferably used for enhancing the sweet taste of a sweet-tasting substance or the sweet odour impression of a flavouring that produces a sweet odour impression, in a preparation for nutrition, oral care or enjoyment.

In addition to the use, explained hereinbefore, of specific substances or substance mixtures, the invention relates in a further aspect also to corresponding preparations in which said substances or substance mixtures are used in the manner according to the invention.

WO 2006/087370 A1 describes the use of synthetically prepared flavouring glycosides, in particular vanillyl glucoside, in foods and enjoyment foods. The aim is for the underlying flavourings to be released completely from the flavouring glycosides after a more or less long time. The disclosed flavouring glycosides are not used as independent flavourings having odour or taste properties or odour- or taste-influencing properties. Propenylphenyl glycosides (in particular the above compounds 1 to 4) are not mentioned in WO 2006/087370 A1.

In a test of our own it has additionally been shown that, according to NMR measurements, the propenyphenyl glycosides to be used according to the invention are not decomposed in the course of one day in deuterium oxide alone or with added saliva, that is to say the observed effects of enhancing the sweet taste are not attributable to the constituents mono- or oligo-saccharide or propenylphenols but are triggered by the propenylphenyl glycosides themselves.

A preparation according to the invention is preferably selected from the group consisting of preparations for nutrition, oral care or enjoyment, semi-finished products, fragrance, flavouring or taste-imparting compositions and spice mixtures. A preparation according to the invention comprises the following components: (a) one or more propenylphenyl glycosides of formula (I)

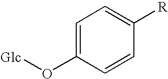

wherein in each case
R is (1)-prop-1-enyl, (1Z)-prop-1-enyl or prop-2-enyl and
Glc is an α- or β-glycosidically bonded mono- or oligo-saccharide as well as
(b) one or more further sweet-tasting substances and/or
(c) one or more flavourings that produce a sweet odour impression,
   wherein the total amount of component (a) in the preparation is sufficient to enhance the sweet taste impression of the sweet-tasting substance(s) (b), or the sweet odour impression of the flavouring(s) (c) that produce a sweet odour impression, overproportionally in sensory terms (i.e. beyond an effect produced by inherent sweetness).

With regard to the preferred meaning of the groups R and Glc in formula (I), the comments made in relation to the use according to the invention apply correspondingly.

Preferably, therefore, in the or in a or in all compounds of formula (I)

Glc is an α- or β-glycosidically bonded mono- or oligo-saccharide selected from the group consisting of D-glucopyranose, D-galactopyranose, D-mannopyranose, maltobiose, cellobiose, lactose, primeverose, neohesperidose and rutinose.

In the preparations according to the invention too, it is advantageous if they comprise as or in component (a):

a propenylphenyl glycoside selected from the group consisting of α- and β-anomers of
1′-O-[4-(propen-2-enyl)phenyl]-D-glucopyranoside (chavicol glucoside, compound 1),
1-O-[4-(propen-2-enyl)phenyl]-6-O-β-D-apiofuranosyl-D-glucopyranoside (furcatin, compound 2),
1′-O-[4-(propen-2-enyl)phenyl]-6-O-β-D-rutinoside (compound 3) or
1-O-[4-(propen-2-enyl)phenyl]-O-β-D-xylopyranosyl-(1-6)-β-D-glucopyranoside (p-allylphenylprimeveroside, miyaginin, compound 4),
   or a mixture of two or more propenylphenyl glycosides from said group.

It should be noted at this point that all comments relating to preferred embodiments of a use according to the invention, of a preparation according to the invention or of a method according to the invention each apply correspondingly to the other aspects of the invention.

A preferred preparation according to the invention comprises as component (b) one or more sugars, wherein the total amount of propenylphenyl glycosides of formula (I) (component (a)) in the preparation is sufficient to impart the same or an enhanced sweetness impression as compared with a preparation or semi-finished product which, while having an otherwise identical composition, does not comprise propenylphenyl glycosides of formula (I) but comprises at least 1.05 times (especially at least 1.2 times, preferably at least 1.4 times) the amount of sugar. The sugars are preferably selected from the group consisting of: sucrose, lactose, glucose, maltose, fructose and mixtures thereof.

Some of the propenylphenyl glycosides of formula (I) which are to be used according to the invention and are present in the preparations according to the invention are known per se. For example, the β-anomer of 1-O-[4-(prop-2-enyl)phenyl]1-D-glucopyranoside (compound 1, CAS Registry Number 64703-98-6) has been described in Cleidon brevipetiofaturm (C. Li, H. Zhou, X. Yang, J. Zhao and L. Li, Tianran Chanwu Yanjiu Kaifa 2004, 16 (6), 514-515). Furcatin (compound 2) has been described in Viburnum furcatum (Tsunao Hase and Tetsuo Iwagawa, Bulletin of the Chemical Society of Japan 1982, 55 (11), 3663-3664). 1-O-[4-(Prop-2-enyl)phenyl]-β-D-glucopyranoside (compound 1) and 1-O-[4-(prop-2-enyl)phenyl]-β-D-rutinoside (β-enantiomer of compound 3) have been found in the rhizome of the plant Alpinia galanga, which is used as a spice (Tram Ngoc Ly, Ryo Yamauchi, Makoto Shimoyamada and Koji Kato, J, Agric. Food Chem. 2002, 50 (17), 4919-4924). 1-O-[4-(Prop-2-enyl)phenyl]-O-β-D-xylopyranosyl-(1-6)-β-D-glucopyranoside (miyaginin, compound 4) has been found in Lespedeza thunbergii (Makoto Ojika, Hiroki Kuyama, Haruki Niwa and Kiyoyuki Yamada, Bulletin of the Chemical Society of Japan 1984, 57 (10), 2893-2896).

α-Anomers of compounds of formula (I), in particular the glycosides mentioned in the last paragraph, are not known; the present invention accordingly also provides them. The invention accordingly relates also to propenylphenyl glycosides of formula (I)

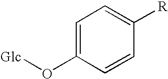

wherein
R is (1E)-prop-1-enyl, (1Z)-prop-1-enyl or prop-2-enyl and
Glc is an α- or β-glycosidically bonded mono- or oligo-saccharide, or

a mixture comprising or consisting of two or more different propenylphenyl glycosides of formula (I) wherein R and Glc in each case have one of the meanings given above.

Particularly preferred α-anomers of formula (I) according to the invention contain as the group Glc an α-glycosidically bonded mono- or oligo-saccharide selected from the group consisting of D-glucopyranose, D-galactopyranose, D-mannopyranose, maltobiose, cellobiose, lactose, primeverose, neohesperidose and rutinose.

The propenylphenyl glycosides (or mixtures thereof) to be used according to the invention can be of natural origin (e.g. from extracts of parts of plants such as Alpinia spp., Cleidon spp., Lespedeza spp. or Viburnum spp.) or can be obtained from chavicol and a carbohydrate derivative with the aid of enzymatic or other chemical processes for glycosidation (see methods described in K. Toshima and K. Tatsuta, Chem. Rev. 1993, 93, 1503-1531, R. J. Ferrier, R. Blattner, R. Furneaux, J. M. Gardiner, P. C. Tyler, R. H. Wightman and N. R. Williams, Carbohydr. Chem. 1996, 28, 19-63 or in Hélène Pellissier, Tetrahedron 2005, 61 (12), 2947-2993).

A preferred preparation according to the invention (as described above, in particular in a preferred embodiment) comprises as or in component (b) one or more further sweet-tasting substances, the further sweet-tasting substance(s) being selected from the group consisting of:

(i) one or more carbohydrates (sugars) selected from the group consisting of sucrose, trehalose, lactose, maltose, melizitose, melibiose, raffinose, palatinose, lactulose, D-fructose, D-glucose, D-galactose, L-rhamnose, D-sorbose, D-mannose, D-tagatose, D-arabinose, L-arabinose, D-ribose, D-glyceraldehyde, maltodextrin and plant preparations containing one or more of the mentioned carbohydrates (preferably in an amount of at least 5 wt. %, preferably at least 15 wt. %), wherein these carbohydrates can also be present in the form of a natural or synthetically prepared mixture (e.g. in the form of honey, invert sugar syrup, highly concentrated fructose syrups from corn starch [high fructose corn syrup]),
(ii) one or more sugar alcohols selected from the group consisting of glycerol, erythritol, threitol, arabitol, ribitol, xylitol, sorbitol, mannitol, maltitol, isomaltitol, dulcitol and lactitol,
(iii) one or more proteins and/or amino acids from the group consisting of miraculin, monellin, thaumatin, curculin, brazzein, glycine, D-leucine, D-threonine, D-asparagine, D-phenylalanine, D-tryptophan, L-proline, or extracts or fractions, obtained from natural sources, containing these amino acids and/or proteins,
(iv) one or more sweeteners from the group consisting of magap, sodium cyclamate, acesulfame K, neohesperidin dihydrochalcone, saccharin sodium salt, aspartame, superaspartame, neotame, alitame, sucralose, stevioside, rebaudioside, lugduname, carrelame, sucrononate, sucrooctate, monatin and phyllodulcin, wherein in the case of the naturally occurring sweeteners, extracts or concentrated fractions of these extracts can also be used, for example stevia extracts, citrus extracts, Buddha tea extracts,
and mixtures thereof and/or
(c) one or more flavourings that produce a sweet odour impression, wherein the further flavouring(s) that produce a sweet odour impression are selected from the group consisting of:
vanillin, ethylvanillin, ethylvanillin isobutyrate (=3-ethoxy-4-isobutyryloxybenzaldehyde), Furaneol® (2,5-dimethyl-4-hydroxy-3(2H)-furanone) and derivatives (e.g. homofuraneol, 2-ethyl-4-hydroxy-5-methyl-3(2H)-furanone), homofuronol (2-ethyl-5-methyl-4-hydroxy-3(2H)-furanone and 5-ethyl-2-methyl-4-hydroxy-3(2H)-furanone), maltol and derivatives (e.g. ethylmaltol), coumarin and derivatives, gamma-lactones (e.g. gamma-undecalactone, gamma-nonalactone), delta-lactones (e.g. 4-methyldeltalactone, massoilactone, deltadecalactone, tuberolactone), methyl sorbate, divanillin, 4-hydroxy-2(or 5)-ethyl-5(or 2)-methyl-3(2H)-furanone, 2-hydroxy-3-methyl-2-cyclopentenone, 3-hydroxy-4,5-dimethyl-2(5H)-furanone, fruit esters and fruit lactones (e.g. acetic acid n-butyl ester, acetic acid isoamyl ester, propionic acid ethyl ester, butyric acid ethyl ester, butyric acid n-butyl ester, butyric acid isoamyl ester, 3-methyl-butyric acid ethyl ester, n-hexanoic acid ethyl ester, n-hexanoic acid allyl ester, n-hexanoic acid n-butyl ester, n-octanoic acid ethyl ester, ethyl-3-methyl-3-phenyl glycidate, ethyl-2-trans-4-cis-decadienoate), 4-(p-hydroxyphenyl)-2-butanone, 1,1-dimethoxy-2,2,5-trimethyl-4-hexane, 2,6-dimethyl-5-hepten-1-al and phenylacetaldehyde.

Preference is given to the use of sweet-tasting substances selected from the group consisting of

(a) sucrose, lactose, D-glucose, maltose, D-tagatose and D-fructose, it also being possible for these carbohydrates to be present in the form of a natural or synthetically prepared mixture (e.g. in the form of honey, invert sugar syrup, highly concentrated fructose syrups from corn starch [high fructose corn syrup]),
(b) erythritol, threitol, arabitol, ribitol, xylitol, sorbitol, mannitol, maltitol, isomaltitol, dulcitol and lactitol,
(c) thaumatin, glycine, D-phenylalanine, D-tryptophan,
(d) sweeteners from the group sodium cyclamate, acesulfame K, neohesperidin dihydrochalcone, saccharin sodium salt, aspartame, superaspartame, neotame, alitame, sucralose, stevioside,
wherein the amount of propenylphenyl glycoside(s) in the preparation is sufficient to sensorially enhance the sweet taste impression of the sweet-tasting substance(s).

Preferably, the total amount of propenylphenyl glycosides of formula (I) in a preparation according to the invention is in the range from 0.1 to 500 ppm, preferably in the range from 1 to 250 ppm, particularly preferably in the range from 50 to 200 ppm, based on the total weight of the preparation.

In particular with the above-mentioned combinations it is possible (as mentioned above) to achieve a synergistic increase in the sweet taste impression.

Preferred sweet-tasting substances have been mentioned above. Sweet-tasting substances (including natural sources of these substances) can generally, but by way of example, be: sweet-tasting carbohydrates or sugars (e.g. sucrose (synonym for saccharose), trehalose, lactose, maltose, melizitose, melibiose, raffinose, palatinose, lactulose, D-fructose, D-glucose, D-galactose, L-rhamnose, D-sorbose, D-mannose, D-tagatose, D-arabinose, L-arabinose, D-ribose, D-glyceraldehyde, maltodextrin) or plant preparations containing mainly these carbohydrates (e.g. from sugar beet (Beta vulgaris spp., sugar fractions, sugar syrup, molasses), from sugar cane (Saccharum officinarum ssp., e.g. molasses, sugar syrup), from sugar maple (Acer spp.), from agave (agave nectar), synthetic/enzymatic hydrolysates of starch or sucrose (e.g. invert sugar syrup, highly concentrated fructose syrups from corn starch), fruit concentrates (e.g. from pears, pear syrup), sugar alcohols (e.g. glycerol, erythritol, threitol, arabitol, ribitol, xylitol, sorbitol, mannitol, maltitol, isomaltitol, dulcitol, lactitol), proteins (e.g. miraculin, monellin, thaumatin, curculin, brazzein), sweeteners (magap, sodium cyclamate, acesulfame K, neohesperidin dihydrochalcone, saccharin sodium salt, aspartame, superaspartame, neotame, alitame, sucralose, stevioside, rebaudioside, lugduname, carrelame, sucrononate, sucrooctate, monatin, phyllodulcin), particular sweet-tasting amino acids (glycine, D-leucine, D-threonine, D-asparagine, D-phenylalanine, D-tryptophan, L-proline), other sweet-tasting low molecular weight substances (e.g. hernandulcin, isocoumarins such as phyllodulcin or hydrangenol, dihydrochalcone glycosides such as neohesperid in dihydrochalcone, glycyrrhizine, glycyrrhetic acid ammonium salt or other glycyrrhetic acid derivatives), extracts of liquorice (Glycyrrhizza glabra spp.), extracts of Lippia dulcis, extracts of or individual substances from Momordica spp. (in particular Momordica grosvenori [Luo Han Guo] and the mogrosides obtained therefrom), from Hydrangea dulcis or from Stevia ssp. (e.g. Stevia rebaudiana).

The preferred flavourings mentioned above are flavourings that produce a sweet odour impression, that is to say flavourings that do not taste sweet in the narrower sense but suggest a sweet taste in the broader sense (in particular including odour perception).

The invention is based on the surprising finding that the propenylphenyl glycosides of formula (I) (or mixtures thereof, as described above) to be used according to the invention, even at very low concentrations (less than 0.025 wt. %, see in this connection the concentration ranges indicated hereinbelow), effect an overproportional (that is to synergistic) increase in the sweet taste impression of sweet-tasting substances (as described above), but in particular of sugars such as sucrose, lactose, glucose, D-tagatose and fructose, as well as of sugar alcohols such as, for example, glycerol, erythritol, threitol, arabitol, ribitol, xylitol, sorbitol, mannitol, dulcitol, lactitol, and it is accordingly possible to lower the sugar content in corresponding foods and enjoyment foods (both as defined above) without at the same time reducing the sweet taste impression. In low concentrations (see in this connection the preferred use concentrations hereinbelow), the propenylphenyl glycosides of formula (I) to be used according to the invention have only a very weak taste of their own. In particular, the propenylphenyl glycosides of formula (I) can also be used in foods and enjoyment foods containing a high proportion of proteins, in particular denatured proteins, or polysaccharides, such as, for example, yoghurt products, in particular those having a pH value in the range from 2 to 7, preferably in the range from 3 to 5. In the preferred concentrations, the propenylphenyl glycosides to be used according to the invention dissolve in aqueous systems to give a clear solution. Preferred concentrations are less than 0.05 wt. % (500 ppm), preferably less than 0.025 wt. % (250 ppm), in particular less than 0.02 wt. % (200 ppm), preferably in the range from 1 to 250 ppm, most preferably in the range from 50 to 200 ppm.

The propenyphenols on which the glycosides to be used according to the invention are based, for example chavicol (4-allylphenol), are not capable on their own of bringing about the described sweetness-enhancing effect. By contrast, they are strong flavourings with in some cases very unpleasant notes (see profile in Example 1), which cannot be assigned to the sweet flavour profile.

It is surprising that the propenylphenyl glycosides of formula (I) are otherwise largely tasteless, in particular because many β-glucosides having substituents other than propenyl substituents in the phenyl ring, for example salicin, 2-(hydroxymethyl)phenyl-β-D-glucopyranoside, 4-carbonylphenyl-β-D-glucopyranoside, 4-ethylphenyl-β-D-gluco-pyranoside, 4-methylphenyl-β-D-glucopyranoside, or the isomer of compound 1,2-allylphenyl-β-D-glucopyranoside, taste very bitter (Nicole Soranzo, Bernd Bufe, Pardis C. Sabeti, James F. Wilson, Michael E. Weale, Richard Marguerie, Wolfgang Meyerhof and David B. Goldstein, Current Biology 2005, 15, 1256-1265 and our own sensory test) and are therefore not suitable per se as flavourings.

The sweet taste of a sweet-tasting substance or the sweet odour impression of a flavouring that produces a sweet odour impression is preferably enhanced in a preparation for nutrition, oral care or enjoyment.

A preferred preparation is a preparation for nutrition, oral care or enjoyment (in particular in one of the embodiments described above as being particularly preferred) comprising a total amount of less than 0.05 wt. % (500 ppm), preferably less than 0.025 wt. % (250 ppm), propenylphenyl glycoside of formula (I), based on the total weight of the preparation.

Even in such low concentrations, the propenylphenyl glycosides, or corresponding mixtures, that are used significantly enhance the sensory effect of sweet-tasting substances or of flavourings that produce a sweet odour impression.

Particular preference is given to preparations for nutrition, oral care or enjoyment (as described above, in particular in embodiments described as being preferred) comprising a total amount in the range from 0.1 to 500 ppm, preferably in the range from 10 to 250 ppm, particularly preferably in the range from 50 to 200 ppm, of propenylphenyl glycosides, based on the total weight of the preparation.

By the use according to the invention of propenylphenyl glycosides it is possible in particular to lower the content of sweet-tasting substances, but in particular of sugars such as sucrose, lactose, fructose and/or glucose, or mixtures thereof, by from 5 to 60% (based on the sweet-tasting substance(s)), as compared with a preparation without propenylphenyl glycosides to be used according to the invention, without the sweet taste impression thereby being reduced.

Preferred preparations according to the invention, which can be sugar-free, reduced-sugar or sugar-containing and are used in particular for nutrition, oral care or enjoyment, are selected from the group consisting of:

(A) confectionery, e.g. white, milk or dark chocolates, filled chocolates (for example with flavoured fondant mass, After Eight type), chocolate bars, other products in bar form, chewy sweets, fruit gums, hard and soft caramels, chewing gum, sugar pearls, lollipops), capsules (preferably seamless capsules for direct consumption, preferably with a casing based on gelatin and/or alginate), chewing gum (e.g. in the form of strips, compressed products, pellets, cushions, spheres, hollow spheres),
(B) alcoholic or non-alcoholic drinks or instant drinks, in particular coffee, tea, wine, drinks containing wine, beer, drinks containing beer, liqueurs, whiskies, brandies, soft drinks containing fruit, isotonic drinks, refreshment drinks, nectars, fruit and vegetable juices with the exception of unchanged apple juice products, fruit or vegetable juice preparations, instant cocoa drinks, instant tea drinks, instant coffee drinks,
(C) cereal products and/or nut products, in particular breakfast cereals, cornflakes, rolled oats, loose muesli, muesli bars, nuts and raisins, sweet popcorn, nut bars, fruit-and-nut bars, pre-cooked finished rice product),
(D) milk products, in particular milk drinks, milk ice, diet ice cream, yoghurt, blancmange, kefir, fresh cheese, soft cheese, hard cheese, dried milk powder, whey, butter, buttermilk, partially or fully hydrolysed milk-protein-containing products,
(E) fruit and/or vegetable preparations, in particular jams, diabetic marmalade, fruit ice, fruit sauces, fruit fillings with the exception of apple products left in the natural state, ketchup, sauces, dried vegetables, frozen vegetables, pre-cooked vegetables, vegetables pickled in vinegar, cooked vegetables,
(F) products based on fat and oil or emulsions thereof, in particular mayonnaise, remoulade, dressings, spice preparations,
(G) an oral care product (oral hygiene product), in particular in the form of toothpaste, tooth cream, tooth gel, tooth powder, tooth-cleaning liquid, tooth-cleaning foam, mouthwash, mouthwash concentrate, tooth cream and mouthwash as a 2-in-1 product, boiled sweet, mouth spray, dental floss, chewing gum or tooth-care chewing gum.

The amount of propenylphenyl glycosides in a preparation according to the invention is preferably sufficient to increase the sweet taste or odour impression significantly by at least 10%, based on a comparable formulation which, while having an otherwise identical composition, does not contain propenylphenyl glycosides.

Preparations according to the invention that are of particular relevance are accordingly those which comprise at least one sweet-tasting substance, preferably a sugar such as sucrose, lactose, glucose and/or fructose, wherein the amount of the sweet-tasting substance is not sufficient to impart a satisfactory sweet taste in a comparable preparation that does not comprise propenyphenyl glycoside but is otherwise of identical composition, wherein the amount of the propenyphenyl glycosides of formula (I) that are present (preferably in one of the embodiments described above as being preferred) in the preparation is sufficient sensorially to enhance the sweet taste impression of the sweet-tasting substance, preferably to such a degree that a satisfactory sweet taste is imparted overall. It has already been stated above that the total amount of propenylphenyl glycosides in the preparation is preferably sufficient to impart the same or an enhanced sweetness impression as compared with a preparation which, while having an otherwise identical composition, does not comprise propenylphenyl glycosides but comprises at least 1.05 times (preferably at least 1.2 times, particularly preferably at least 1.4 times) the amount of sugar.

Preferred preparations according to the invention are preparations for nutrition, oral care or enjoyment, for which the comments made above apply in respect of their compositions.

The preparations for nutrition, oral care or enjoyment according to the invention are generally products which are intended to be introduced into the human oral cavity, remain there for a particular time and then be either consumed (e.g. ready-to-eat foods) or removed from the oral cavity again (e.g. chewing gums or toothpaste). It goes without saying that the use of the propenylphenyl glycosides of formula (I) to be used according to the invention is intended for any type of such products. These products include all substances or products which are to be taken in the processed, partially processed or unprocessed state into the oral cavity by human beings. They also include substances which are added to foods during their preparation, processing or treatment and which are intended to be introduced into the human oral cavity.

It goes without saying that the propenylphenyl glycosides of formula (I) to be used according to the invention can be used in particular in foods. Within the scope of the present text, “foods” are to be understood as being in particular substances which are intended to be swallowed and then digested by humans in the unchanged, prepared or processed state; in this respect, foods also include casings, coatings or other coverings which are intended to be swallowed as well or for which swallowing is to be anticipated. Particular products that are usually removed from the oral cavity again (e.g. chewing gums) are also to be understood as being foods within the scope of the present text, because it cannot be ruled out that they will not be swallowed at least partially.

The propenylphenyl glycosides to be used according to the invention are used in particular in ready-to-eat foods. A ready-to-eat food is to be understood as meaning a food that is already complete in respect of the substances that are significant for the taste. The term “ready-to-eat food” also includes corresponding drinks as well as solid or semi-solid ready-to-eat foods. Examples which may be mentioned are frozen products, which are defrosted prior to consumption and must be heated to room temperature. Products such as yoghurt or ice cream, but also chewing gums or hard caramels, belong to the ready-to-eat foods.

The propenylphenyl glycosides to be used according to the invention can also be used in semi-finished food products. The term semi-finished food products here relates to foods which are intended to be consumed only in the further processed state, after addition of flavourings or taste-imparting substances that (also) determine the sensory impression.

A preparation for oral care (oral care product, also called an oral hygiene product or oral hygiene preparation) within the scope of the invention is understood as being a preparation for cleaning and caring for the oral cavity and the pharynx and for freshening the breath. Care of the teeth and gums is expressly excluded. Forms of administration for conventional oral hygiene formulations are creams, gels, pastes, foams, emulsions, suspensions, aerosols, sprays as well as capsules, granules, pastilles, lozenges, sweets or chewing gums, this list not being limiting for the purposes of this invention.

Further conventional active ingredients, basic ingredients, auxiliary substances and additives for preparations according to the invention for nutrition, oral care or enjoyment can be present in amounts of from 5 to 99.999999 wt. %, preferably from 10 to 80 wt. %, based on the total weight of the preparation. The preparations can further contain water in an amount of up to 99.999999 wt. %, preferably from 5 to 80 wt. %, based on the total weight of the preparation.

The present invention relates in particular to a preparation for nutrition, oral care or enjoyment comprising

a component (a) which comprises one or more propenylphenyl glycosides of formula I or consists of one or more propenylphenyl glycosides of formula I,
a component (b) (i.e. one or more sweet-tasting substances) comprising or consisting of one or more sugars
as well as optionally
component (c) (i.e. one or more flavourings that produce a sweet odour impression),
wherein the total amount of component (a) in the preparation (i.e. the total amount of propenylphenyl glycosides of formula (I) as described above)
is sufficient to impart the same or an enhanced sweetness impression as compared with a preparation which, while having an otherwise identical composition, does not comprise propenylphenyl glycosides of formula (I) but comprises at least 1.05 times the amount of sugar and/or
is in the range from 0.1 to 500 ppm, preferably from 1 to 250 ppm, particularly preferably from 50 to 200 ppm.

Preferred preparations according to the invention are semi-finished products, fragrance, flavouring or taste-imparting compositions or spice mixtures.

The term semi-finished products includes in particular semi-finished food products, see above.

Semi-finished products according to the invention can also be in spray-dried form. Preparations according to the invention can also be in the form of capsules, tablets (uncoated and coated tablets, e.g. enteric coatings), dragées, granules, pellets, solids mixtures, dispersions in liquid phases, in the form of emulsions, in the form of powders, in the form of solutions, in the form of pastes or in the form of other swallowable or chewable preparations as food supplements.

Preparations according to the invention in the form of semi-finished products can be used in particular to enhance the sweet taste impression of finished preparations for nutrition, oral care or enjoyment which are produced using the semi-finished preparation.

Spray-dried solid preparations according to the invention in the form of semi-finished products are particularly suitable for the production of preparations according to the invention which can be used in particular for nutrition, oral care or enjoyment. In the spray-dried semi-finished products, the solubility of the propenylphenyl glycosides of formula (I) to be used according to the invention is substantially improved by carriers and/or auxiliary substances, in particular by maltodextrin, starches, natural or synthetic polysaccharides and/or plant gums, such as modified starches or gum arabic. The spray-dried solid semi-finished products according to the invention preferably contain from 50 to 95 wt. % carriers, in particular maltodextrin and/or starch, from 5 to 40 wt. % auxiliary substances, preferably natural or synthetic polysaccharides and/or plant gums, such as modified starches or gum arabic, and from 1 to 45 wt. % propenylphenyl glycosides of formula (I) to be used according to the invention, based on the total weight of the spray-dried solid preparation.

Preparations according to the invention selected from the group consisting of semi-finished products, fragrance, flavouring or taste-imparting compositions and spice mixtures preferably comprise a total amount of propenylphenyl glycosides of formula (I) in the range from 0.0001 wt. % to 95 wt. %, preferably from 0.001 wt. % to 80 wt. %, particularly preferably from 0.001 wt. % to 50 wt. %, based on the total weight of the preparation.

The preparations according to the invention can preferably also contain a flavouring composition in order to round out and refine the taste and/or odour of the preparation. Suitable flavouring compositions contain, for example, synthetic, natural or nature-identical flavouring, fragrance and taste-imparting substances as well as suitable auxiliary substances and carriers. Particular preference is given to preparations according to the invention that contain one or more flavourings that produce a “sweet” odour impression (see above).

Semi-finished products according to the invention generally comprise further taste-imparting substances and/or flavourings, in particular flavourings that produce a sweet odour impression (see above), as well as suitable solvents (e.g. ethanol, glycerol, 1,2-propylene glycol, alkyl esters of lactic acid, ethyl esters of organic fruit acids such as diethyl malonate, diethyl tartrate, diethyl malate, triethyl citrate, diethyl succinate, diethyl fumarate, diethyl maleate) and further auxiliary substances (e.g. colourings, pigments, antioxidants, preservatives, emulsifiers, substances that influence viscosity).

Spray-dried solid semi-finished products according to the invention preferably comprise from 1 to 50 wt. % propenylphenyl glycosides of formula (I) to be used according to the invention, based on the total weight of the preparation, from 0 to 10 wt. %, preferably from 1 to 10 wt. %, other flavourings, from 50 to 99 wt. % carriers and from 0 to 50 wt. %, preferably from 1 to 50 wt. %, further auxiliary substances and/or stabilisers, in each case based on the total weight of the preparation.

Advantageous carriers in the spray-dried solid preparations according to the invention are carbohydrates and/or carbohydrate polymers (polysaccharides). As preferred carriers in the flavouring particles to be used according to the invention there may be mentioned, for example, hydrocolloids such as starches, degraded starches, chemically or physically modified starches, modified celluloses, gum arabic, ghatti gum, tragacanth, karaya, carrageenan, guar flour, locust bean flour, alginates, pectin, inulin or xanthan gum, dextrins and maltodextrins.

The degree of decomposition of the starch is measured by the parameter “dextrose equivalent” (DE), which can assume the limiting value 0 for the long-chained glucose polymer starch and 100 for pure glucose.

Particularly preferred carriers for the spray-dried solid preparations according to the invention are maltodextrins, maltodextrins having DE values in the range from 10 to 30 in turn being advantageous.

It has already been mentioned that spray-dried solid semi-finished products are particularly suitable for the production of preparations according to the invention which are to be used for nutrition, oral care or enjoyment.

As already mentioned, the propenylphenyl glycosides of formula (I) are not always readily soluble in conventional solvents (suitable for consumption). Therefore, it was an additional object of the present invention to improve the solubility of the propenylphenyl glycosides of formula (I), or of corresponding mixtures, to be used according to the invention, in particular in fragrance, flavouring or taste-imparting compositions, but also generally in preparations for nutrition, oral care or enjoyment. This object is achieved according to the invention by the use of an additional component (d) in a preparation according to the invention, component (d) comprising specific esters and/or solvents.

A preferred preparation according to the invention comprises as the additional component (d) one or more esters selected from the group consisting of lactic acid C₁-C₆-esters, tartaric acid C₁-C₄-esters, succinic acid di-C₁-C₄-esters, malonic acid di-C₁-C₄-esters, malic acid di-C₁-C₄-esters, citric acid di-C₁-C₄-esters and citric acid tri-C₁-C₄-esters and/or

one or more solvents selected from the group consisting of 1,2-propylene glycol, dimethyl sulfoxide, ethanol and ethanol/water mixtures.

In addition to the additional component (d), one or more further flavourings are also preferably present, in particular flavourings that produce a sweet odour impression and are preferably selected from the above-indicated group of such flavourings.

Esters that can particularly preferably be used for increasing the solubility of the propenylphenyl glycosides of formula (I) to be used according to the invention, or their salts or corresponding mixtures, are esters selected from the group consisting of ethyl lactate, n-propyl lactate, n-butyl lactate, diethyl tartrate, dimethyl succinate, diethyl succinate, dimethyl malonate, diethyl malonate, dimethyl malate, diethyl malate and triethyl citrate, as well as the solvent 1,2-propylene glycol.

Fragrance, flavouring or taste-imparting compositions according to the invention that comprise the above-mentioned esters or solvents effect very good solubility and prevent an appreciable tendency to recrystallisation of the propenylphenyl glycosides of formula (I), or of the corresponding mixtures, to be used according to the invention. They are therefore particularly suitable for incorporation into the preparations according to the invention for nutrition, oral care or enjoyment. With regard to the preferred concentrations of the propenylphenyl glycosides in fragrance, flavouring or taste-imparting compositions according to the invention, reference is made to the comments above.

Preparations according to the invention for nutrition, oral care or enjoyment are preferably produced by incorporating the propenylphenyl glycosides of formula (I) without a solvent, in the form of a solution (e.g. in ethanol, water, 1,2-propylene glycol, dimethyl sulfoxide, optionally in the presence of one of the above-mentioned esters or solvents) or in the form of a mixture with a solid or liquid carrier (e.g. maltodextrin, starch, silica gel), flavours or flavourings and optionally further auxiliary substances and/or stabilisers (e.g. natural or synthetic polysaccharides and/or plant gums, such as modified starches or gum arabic), that is to say in the form of a semi-finished product, into a base preparation for nutrition, oral care or enjoyment. Preparations according to the invention in the form of a solution and/or suspension or emulsion can advantageously first be converted into a solid preparation according to the invention (semi-finished product) by spray-drying, before the solid preparation is in turn used in the production of preparations according to the invention for nutrition, oral care or enjoyment. With regard to the particular suitability of spray-dried semi-finished products for the production of preparations for nutrition, oral care or enjoyment, reference is made to the comments above.

According to a further preferred embodiment, for the production of preparations according to the invention the propenylphenyl glycosides of formula (I) to be used according to the invention, and optionally other constituents of the preparation according to the invention, are first incorporated into emulsions, into liposomes, e.g. based on phosphatidyl choline, into microspheres, into nanospheres or alternatively into capsules, granules or extrudates from a matrix suitable for foods and enjoyment foods, (both as defined above) e.g. from starch, starch derivatives (e.g. modified starch), cellulose or cellulose derivatives (e.g. hydroxypropylcellulose), other polysaccharides (e.g. dextrin, alginate, curdian, carrageenan, chitin, chitosan, pullulan), natural fats, natural waxes (e.g. beeswax, carnauba wax), from proteins, e.g. gelatin, or other natural products (e.g. shellac). Depending on the matrix, the products can be obtained by spray drying, spray granulation, melt granulation, fluidised bed processes (e.g. according to WO 97/16078 or WO 2004/022642), fluidised bed spray granulation (e.g. according to WO 00/36931 or U.S. Pat. No. 4,946,654), coacervation, coagulation, extrusion, melt extrusion (e.g. according to WO 2003/092412, EP 1 123 660 or EP 1 034 705), emulsion processes, coating or other suitable encapsulation processes and optionally a suitable combination of the above-mentioned processes. In a further preferred production process for a preparation according to the invention, the propenylphenyl glycosides to be used according to the invention are first complexed with one or more suitable complexing agents, for example with cyclodextrins or cyclodextrin derivatives, preferably alpha- or beta-cyclodextrin, and are used in this complexed form.

Preference is given in some cases to a preparation according to the invention in which the matrix is so chosen that the propenylphenyl glycosides of formula (I) to be used according to the invention are released from the matrix in a delayed manner, so that a long-lasting action is achieved. Particular preference is given in this connection to a fat, wax, polysaccharide or protein matrix.

As further constituents of preparations for nutrition or enjoyment according to the invention there may be used base substances, auxiliary substances and additives conventional for foods or enjoyment foods (both as defined above), for example water, mixtures of fresh or processed, vegetable or animal base or raw substances (e.g. raw, roast, dried, fermented, smoked and/or boiled meat, bone, cartilage, fish, vegetables, fruits, herbs, nuts, vegetable or fruit juices or pastes or mixtures thereof), digestible or non-digestible carbohydrates (e.g. saccharose, maltose, fructose, glucose, dextrins, amylose, amylopectin, inulin, xylans, cellulose, tagatose), sugar alcohols (e.g. sorbitol, erythritol), natural or hardened fats (e.g. tallow, lard, palm oil, coconut fat, hardened vegetable fat), oils (e.g. sunflower oil, groundnut oil, maize oil, olive oil, fish oil, soybean oil, sesame oil), fatty acids or their salts (e.g. potassium stearate), proteinogenic or non-proteinogenic amino acids and related compounds (e.g. γ-aminobutyric acid, taurine), peptides (e.g. glutathione), natural or processed proteins (e.g. gelatin), enzymes (e.g. peptidases), nucleic acids, nucleotides, other taste-correcting agents for unpleasant taste impressions, further taste modulators for further, generally not unpleasant taste impressions, other taste-modulating substances (e.g. inositol phosphate, nucleotides such as guanosine monophosphate, adenosine monophosphate or other substances such as sodium glutamate or 2-phenoxypropionic acid), emulsifiers (e.g. lecithins, diacylglycerols, gum arabic), stabilisers (e.g. carrageenan, alginate), preservatives (e.g. benzoic acid, sorbic acid), antioxidants (e.g. tocopherol, ascorbic acid), chelators (e.g. citric acid), organic or inorganic acidifying agents (e.g. malic acid, acetic acid, citric acid, tartaric acid, phosphoric acid), bitter substances (e.g. quinine, caffeine, limonine, amarogentin, humulones, lupolones, catechols, tannins), mineral salts (e.g. sodium chloride, potassium chloride, magnesium chloride, sodium phosphates), substances that prevent enzymatic browning (e.g. sulfite, ascorbic acid), essential oils, plant extracts, natural or synthetic colourings or colouring pigments (e.g. carotinoids, flavonoids, anthocyanins, chlorophyll and derivatives thereof), spices, substances having trigeminal action or plant extracts containing such substances having trigeminal action, synthetic, natural or nature-identical flavourings or fragrances and also odour-correcting agents.

Tooth care agents (as an example of an oral care product according to the invention) containing the propenylphenyl glycosides of formula (I) to be used according to the invention generally comprise an abrasive system (abrasive or polishing agent), such as, for example, silicas, calcium carbonates, calcium phosphates, aluminium oxides and/or hydroxyl apatites, surface-active substances, such as, for example, sodium lauryl sulfate, sodium lauryl sarcosinate and/or cocamidopropylbetain, humectants, such as, for example, glycerol and/or sorbitol, thickeners, such as, for example, carboxymethylcellulose, polyethylene glycols, carrageenan and/or Laponite®, sweeteners, such as, for example, saccharin, taste-correcting agents for unpleasant taste impressions, taste-correcting agents for further, generally not unpleasant taste impressions, taste-modulating substances (e.g. inositol phosphate, nucleotides such as guanosine monophosphate, adenosine monophosphate or other substances such as sodium glutamate or 2-phenoxypropionic acid), cooling active ingredients, such as, for example, menthol, menthol derivatives (e.g. L-menthol, L-menthyl lactate, L-menthyl alkylcarbonates, menthone ketals, menthanecarboxylic acid amides), 2,2,2-trialkylacetic acid amides (e.g. 2,2-diisopropylpropionic acid methylamide), icilin and icilin derivatives, stabilisers and active ingredients, such as, for example, sodium fluoride, sodium monofluorophosphate, tin difluoride, quaternary ammonium fluorides, zinc citrate, zinc sulfate, tin pyrophosphate, tin dichloride, mixtures of various pyrophosphates, triclosan, cetylpyridinium chloride, aluminium lactate, potassium citrate, potassium nitrate, potassium chloride, strontium chloride, hydrogen peroxide, flavourings and/or sodium bicarbonate or odour-correcting agents.

Chewing gums (as a further example of preparations for oral care) which contain the propenylphenyl glycosides of formula (I) to be used according to the invention generally comprise a chewing gum base, that is to say a chewable mass which becomes plastic when chewed, sugars of various types, sugar substitutes, other sweet-tasting substances, sugar alcohols, taste-correcting agents for unpleasant taste impressions, other taste modulators for further, generally not unpleasant taste impressions, taste-modulating substances (e.g. inositol phosphate, nucleotides such as guanosine monophosphate, adenosine monophosphate or other substances such as sodium glutamate or 2-phenoxypropionic acid), humectants, thickeners, emulsifiers, flavourings and stabilisers or odour-correcting agents.

A particularly preferred preparation according to the invention comprises at least one further substance for masking or reducing a bitter, metallic, chalky, acidic or astringent taste impression or for enhancing a sweet, salty or umami taste impression. Accordingly, one or more of the propenylphenyl glycosides of formula (I) to be used according to the invention, or corresponding mixtures, are used in combination with at least one (further) substance suitable for masking or reducing an unpleasant (bitter, chalky, acidic, astringent) taste impression or for enhancing a pleasant taste impression (sweet, salty, umami). These special preparations are outstandingly suitable for achieving a particularly effective enhancement of the sweetness in the preparations according to the invention containing sweet-tasting substances. Preference is given in particular to the combination of the propenylphenyl glycosides of formula (I) to be used according to the invention with taste-correcting substances for unpleasant, in particular bitter, taste impressions, or taste enhancers for pleasant, in particular sweet, taste impressions.

Particular preference is given to preparations according to the invention that comprise hesperetin and/or phloretin or salts thereof.

A particularly preferred combination is accordingly obtained by the use of the propenylphenyl glycosides of formula (I) together with hesperetin and/or phloretin or salts thereof for enhancing the sweetness of the above-mentioned sweet-tasting substances, in particular sugars. With regard to the sweetness-enhancing action of hesperetin, reference is made to PCT/EP2006/06433 and the documents based thereon (Symrise), and in respect of phloretin to US Provisional Application 64/784,444 and the documents based thereon (Symrise). The total content of propenylphenyl glycosides of formula (I) here is preferably not more than 0.02 wt. % (200 ppm) and the total content of hesperetin or phloretin is preferably not more than 0.01 wt. % (100 ppm) in each case, based in each case on the total weight of the preparation. The indicated total contents relate to ready-for-use preparations for nutrition, oral care or enjoyment. In semi-finished products, fragrance, flavouring or taste-imparting compositions, the total content will be correspondingly markedly higher. The ratio of the total amount of the propenylphenyl glycosides of formula (I) to the total amount of hesperetin or phloretin, or their salts, that is used is especially in the range from 1000:1 to 1:1000, preferably in the range from 10:1 to 1:10, particularly preferably in the range from 5-1 to 1:5 and most particularly preferably in the range from 7:3 to 3:7, the ratio of hesperetin to phloretin or salts thereof especially being in the range from 1000:1 to 1:1000, preferably in the range from 10:1 to 1:10, particularly preferably in the range from 5:1 to 1:5 and most particularly preferably in the range from 7:3 to 3:7.

Hesperetin has the following structural formula:

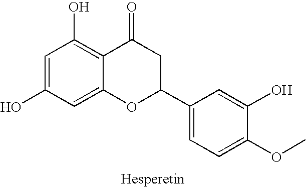

Phloretin has the following structural formula:

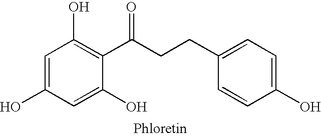

wherein the hesperetin and/or salts thereof (in particular in the form of the Na⁺, K⁺, NH₄⁺, Ca²⁺, Mg²⁺, Al³⁺ and/or Zn²⁺ salts) can be present in the form of the (2S) enantiomer, (2R) enantiomer or any desired mixture of the enantiomers, preferably in a mixture which contains equal parts of the enantiomers or in which the (2S) enantiomer accounts for more than 50% of the total weight of the hesperetin enantiomers.

The (further) taste-correcting substances are selected, for example, from the following list: nucleotides (e.g. adenosine 5′-monophosphate, cytidine 5′-monophosphate) or pharmaceutically acceptable salts thereof lactisols, sodium salts (e.g. sodium chloride, sodium lactate, sodium citrate, sodium acetate, sodium gluconoate), further hydroxy-flavanones (e.g. eriodictyol, homoeriodictyol or sodium salts thereof), in particular according to US 2002/0188019, hydroxybenzoic acid amides according to DE 10 2004 041 496 (e.g. 2,4-dihydroxybenzoic acid vanillylamide, 2,4-dihydroxybenzoic acid N-(4-hydroxy-3-methoxybenzyl)amide, 2,4,6-trihydroxybenzoic acid N-(4-hydroxy-3-methoxybenzyl)amide, 2-hydroxybenzoic acid N-4-(hydroxy-3-methoxybenzyl)amide, 4-hydroxybenzoic acid N-(4-hydroxy-3-methoxybenzyl)amide, 2,4-dihydroxybenzoic acid N-(4-hydroxy-3-methoxybenzyl)amide monosodium salt, 2,4-dihydroxybenzoic acid N-2-(4-hydroxy-3-methoxyphenyl)ethylamide, 2,4-dihydroxybenzoic acid N-(4-hydroxy-3-ethoxybenzyl)amide, 2,4-dihydroxybenzoic acid N-(3,4-dihydroxybenzyl)amide and 2-hydroxy-5-methoxy-N-[2-(4-hydroxy-3-methoxyphenyl)ethylamide (aduncamide), 4-hydroxybenzoic acid vanillylamide), bitterness-masking hydroxydeoxybenzoins according to PCT/EP2006/060591 (U.S. Provisional Application 60/668,189) and the documents based thereon (Symrise) (e.g. 2-(4-hydroxy-3-methoxyphenyl)-1-(2,4,6-trihydroxyphenyl)ethanone, 1-(2,4-dihydroxyphenyl)-2-(4-hydroxy-3-methoxyphenyl)-ethanone, 1-(2-hydroxy-4-methoxyphenyl)-2-(4-hydroxy-3-methoxyphenyl)ethanone), amino acids (e.g. gamma-aminobutyric acid according to WO 2005/096841 for reducing or masking an unpleasant taste impression, such as bitterness), malic acid glycosides according to WO 2006/003107, salty-tasting mixtures according to U.S. Provisional Application 60/728,744 (PCT/EP2006/067120) and the documents based thereon (Symrise), diacetyl trimers according to WO 2006/058893 and the documents based thereon (Symrise), mixtures of whey proteins with lecithins and/or bitterness-masking substances such as ginger diones according to U.S. Provisional Application 60/696,670 (PCT/EP2006/063576) and the documents based thereon (Symrise).

It has already been stated several times that preparations according to the invention are selected in particular from the group consisting of preparations for nutrition, oral care or enjoyment, semi-finished products, fragrance, flavouring or taste-imparting compositions and spice mixtures. Preferred preparations according to the invention are mentioned hereinbelow: baked goods (e.g. bread, dry biscuits, cakes, muffins, waffles, baking mixtures, other baked goods), confectionery (e.g. white, milk or dark chocolates, filled chocolates (for example with flavoured fondant mass, After Eight type), chocolate bars, other products in bar form, chewy sweets, fruit gums, hard and soft caramels, chewing gum, sugar pearls, lollipops), capsules (preferably seamless capsules for direct consumption, preferably with a casing based on gelatin and/or alginate), fatty masses (e.g. fillings for baked goods for e.g. biscuit fillings, fatty fillings for chocolates, fatty fillings for bars), toppings, alcoholic or non-alcoholic drinks (e.g. coffee, tea, wine, drinks containing wine, beer, drinks containing beer, liqueurs, whiskies, brandies, soft drinks containing fruit, isotonic drinks, refreshment drinks, nectars, fruit and vegetable juices with the exception of unchanged apple juice products, fruit or vegetable juice preparations), instant drinks or instant powders (e.g. instant cocoa drinks, instant tea drinks, instant coffee drinks, instant desserts in powder form such as blancmange powder or jelly), meat products (e.g. ham, fresh sausage or raw sausage preparations, spiced or marinated fresh or salt meat products), eggs or egg products (e.g. dried egg powder), cereal products and/or nut products (e.g. breakfast cereals, cornflakes, rolled oats, loose muesli, muesli bars, nuts and raisins, sweet popcorn, nut bars, fruit-and-nut bars, pre-cooked finished rice product), milk products (e.g. milk drinks, milk ice, yoghurt, blancmange, kefir, fresh cheese, soft cheese, hard cheese, dried milk powder, whey, butter, buttermilk, partially or fully hydrolysed milk-protein-containing products), products made from soya protein or other soybean fractions (e.g. soya milk and products produced therefrom, soya-lecithin-containing preparations, fermented products such as tofu or tempe or products made therefrom, soya sauces), fruit preparations (e.g. jams, fruit ice, fruit sauces, fruit fillings with the exception of apple products left in the natural state), vegetable preparations (e.g. ketchup, sauces, dried vegetables, frozen vegetables, pre-cooked vegetables, vegetables pickled in vinegar, cooked vegetables), snack articles (e.g. baked or fried potato crisps or potato pulp products, bread dough products, corn- or peanut-based extrudates), products based on fat and oil or emulsions thereof (e.g. mayonnaise, remoulade, dressings, spice preparations), other ready meals and soups (e.g. dried soups, instant soups, pre-cooked soups), spices, spice mixtures and also, especially, seasonings, which are used, for example, in the snacks sector.

Preparations according to the invention can also be in the form of capsules, tablets (uncoated and coated tablets, e.g. enteric coatings), dragées, granules, pellets, solids mixtures, dispersions in liquid phases, in the form of emulsions, in the form of powders, in the form of solutions, in the form of pastes or in the form of other swallowable or chewable preparations as food supplements.

The present invention relates also to a method for enhancing the sweet taste or the sweet odour impression of a flavouring that produces a sweet odour impression, comprising the following step:

one or more sweet-tasting substances (component (b)) or one or more flavourings that produce a sweet odour impression (component (c)) is/are mixed with a total amount of a component (a) as defined above, that is to say with a total amount of a propenylphenyl glycoside of formula (I), wherein the total amount of component (a) in the preparation is sufficient sensorially to enhance the sweet taste impression of the sweet-tasting substance(s) (b) or the sweet odour impression of the flavouring(s) (c) that produce a sweet odour impression.

With regard to the preferred amounts of propenylphenyl glycosides of formula (I) to be used according to the invention, see above. A total concentration of at least 50 ppm and not more than 200 ppm in a ready-for-use preparation for oral care or a ready-to-eat preparation for nutrition or enjoyment is often particularly preferred.

In general, however, the comments made above in respect of the use according to the invention and the preparations according to the invention apply also to the method according to the invention.

### EXAMPLES

The examples serve to illustrate the invention without limiting it. Unless indicated otherwise, all amounts are by weight.

### Example 1

### Chavicol β-D-glucopyranoside, compound 1

The synthesis was carried out according to the following scheme via the α-trichloroacetimidate F:

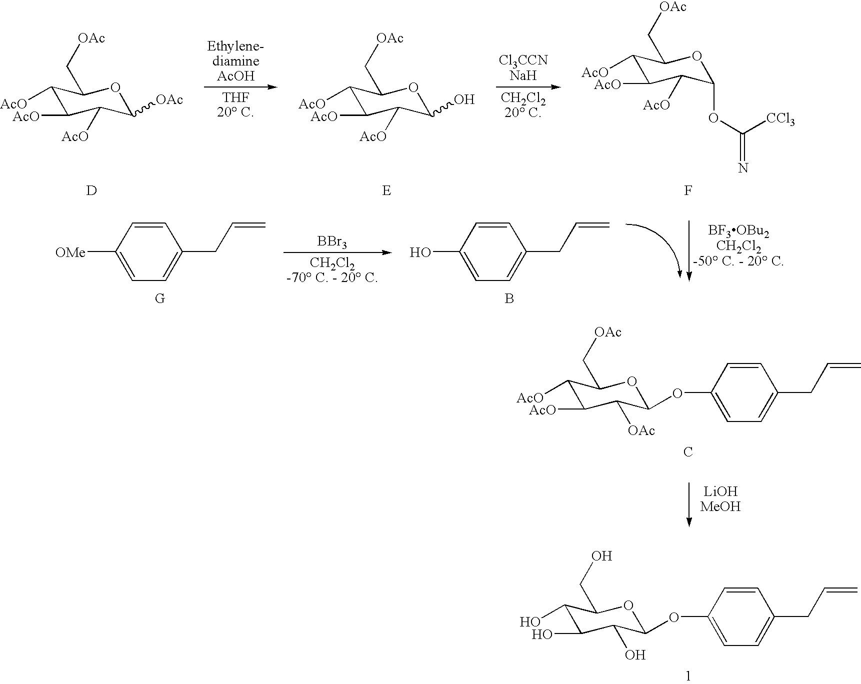

Alternatively, the synthesis was also carried out via the β-trichloroacetimidate A (according to the scheme below). Owing to the adjacent-group-effect of the acetyl group in the 2-position in compounds A and F, glycosidation with both A and F yields the β-anomer C.

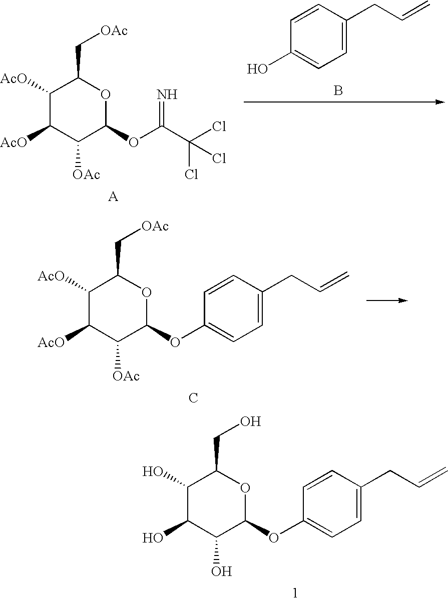

### 2,3,4,6-Tetra-O-acetyl-D-glucose, compound E

10 ml of ethylenediamine (0.15 mol, 1.5 eq.) are placed in 350 ml of dry tetrahydrofuran, and 8.41 g of conc. acetic acid (0.14 mol, 1.4 eq.) are added dropwise, with stirring. 39.04 g of D-glucose pentaacetate (0.10 mol, 1.0 eq.) are added, and stirring is carried out for 24 hours at room temperature.

250 ml of dichloromethane are added to the reaction mixture; washing is carried out with 100 ml of each of water, 10% hydrochloric acid and saturated sodium hydrogen carbonate solution, the mixture is dried over sodium sulfate and the solvent is distilled off in vacuo.

25.8 g of a mixture of the two anomers of 2,3,4,6-tetra-O-acetyl-D-glucose having a purity >90% (NMR) are obtained. Anomer distribution approx. α/β=3/1.

¹H-NMR (CDCl₃, 400 MHz): δ=2.02 (s, 3H), 2.04 (s, 3H), 2.09 (s, 3H), 2.10 (s, 3H), 3.73-3.79 (m, 1Hα), 4.11-4.18 (m, 1H), 4.21-4.30 (m, 2H), 4.76 (d, J=8.0 Hz, 1Hβ), 4.89 (dd, J=3.6, 10.3 Hz, 1Hα), 4.90 (dd, J=8.0, 9.8 Hz, 1Hβ), 5.09 (dd, J=9.4, 10.1 Hz, 1H), 5.25 (dd, J=9.7, 9.4 Hz, 1Hβ), 5.46 (d, J=3.6 Hz, 1Hα), 5.54 (dd, J=9.4, 10.2 Hz, 1H).

α-Anomer, ¹³C-NMR (100 MHz, CDCl₃): δ=20.6, 20.7, 20.7, 20.8 (OH₃), 62.0 (CH₂), 67.1, 68.5, 69.9, 71.2, 90.1 (CH), 169.7, 170.3, 170.3, 171.0 (C).

β-Anomer: ¹³C-NMR (100 MHz, CDCl₃): δ=20.6, 20.7, 20.7, 20.8 (CH₃), 62.0 (CH₂), 68.4, 72.0, 72.3, 73.2, 95.5 (CH), 169.6, 170.3, 170.8, 170.9 (C).

### 2,3,4,6-Tetra-O-acetyl-α-D-glucopyranosyl trichloroacetimidate, compound F

25.8 g of 2,3,4,6-tetra-O-acetyl-D-glucose (74 mmol, 1.0 eq.) and 22.3 ml of trichloroacetonitrile (222 mmol, 3.0 eq.) are placed in 150 ml of dry dichloromethane. 3.0 g of sodium hydride (125 mmol, 1.7 eq.) are added carefully at −5° C., with stirring. After 30 minutes, excess sodium hydride is filtered off over Kieselguhr and the filtrate is concentrated in vacuo.

The crude product is chromatographed on silica gel 60 with diethyl ether. Approximately 8.5 g of 2,3,4,6-tetra-O-acetyl-α-D-glucopyranosyl trichloroacetimidate F are obtained.

(R. R. Schmidt, M. Stumpp, Liebigs Ann. Chem. 1983, 1249-1256)

¹H-NMR (CDCl₃, 400 MHz): δ=2.02 (s, 3H), 2.04 (s, 3H), 2.05 (s, 3H), 2.08 (s, 3H), 4.13 (dd, J=2.1, 12.3 Hz, 1H), 4.20-4.25 (m, 1H), 4.28 (dd, J=3.7, 12.3 Hz, 1H), 5.14 (dd, J=3.7, 10.2 Hz, 1H), 5.19 (dd, J=9.5, 10.1 Hz, 1H), 5.57 (dd, J=9.9, 10.1 Hz), 6.57 (d, J=3.7 Hz, 1H), 8.70 (s, 1H, N—H).

¹³C-NMR (100 MHz, CDCl₃): δ=20.5, 20.6, 20.7, 20.7 (CH₃), 61.4 (CH₂), 67.8, 69.7, 69.9, 70.0 (CH), 90.7 (C), 92.9 (CH), 160.8, 169.5, 169.9, 170.0, 170.6 (C).

### 4-Allylphenol, chavicol, compound B

7.41 g of 4-allylanisole G (0.05 mol, 1.0 eq.) are placed in 100 ml of dichloromethane. 50 ml of a 1.0 M solution of boron tribromide (0.05 mol, 1.0 eq.) in dichloromethane is added dropwise at −65 to −70° C., with stirring, and the reaction temperature is allowed to rise to room temperature in the course of 2 hours. The reaction is terminated by the very careful addition of 25 ml of ice and 25 ml of ice-water.

The organic phase is extracted twice with 30 ml of 10% sodium hydroxide solution (0.15 mol) each time, washed once with 75 ml of diethyl ether and acidified with 70 ml of 10% hydrochloric acid. The solution is saturated by addition of sodium chloride, and the 4-allylphenol is extracted with 2×75 ml of diethyl ether.

The organic phase is dried over sodium sulfate, and the solvent is distilled off in vacuo. Approximately 7.0 g of 4-allylphenol B having a purity of approximately 90% (GC) are obtained.

¹H-NMR (CDCl₃, 400 MHz): δ=3.31 (d, J=6.67 Hz, 2H), 5.02-5.08 (m, 3H), 5.94 (mc, 1H), 6.74-6.78 (m, 2H), 7.02-7.07 (m, 2H).

¹³C-NMR (100 MHz, CDCl₃): δ=39.3 (CH₂), 115.3 (2×CH), 115.5 (CH₂), 129.7 (2×CH), 132.3 (C), 137.8, 137.8 (CH), 153.7 (C).

### 2,3,4,6-Tetra-O-acetyl-β-D-glucopyranosyl-4-allylbenzene, compound C

8.5 g of 2,3,4,6-tetra-O-acetyl-α-D-glucopyranosyl trichloroacetimidate F (17.2 mmol, 1.0 eq.), 2.58 g of 4-allylphenol B (17.2 mmol, 1.0 eq.) and 10 g of 4 Å molecular sieve are placed in 150 ml of dry dichloromethane. The mixture is cooled to −50° C., and 0.68 g of boron trifluoride diethyl etherate (3.44 mmol, 0.2 eq.) is added dropwise, with stirring. Stirring is carried out for one hour at −50° C. and for 16 hours at room temperature. The molecular sieve is filtered off, washing with 75 ml of saturated sodium hydrogen carbonate solution is carried out, the mixture is dried over sodium sulfate and the solvent is distilled off in vacuo.

The crude product is dissolved in 30 ml of ethanol and left to stand at 5° C. The crystals are filtered off, and drying in vacuo yields approximately 4.5 g of 2,3,4,6-tetra-O-acetyl-β-D-glucopyranosyl-4-allylbenzene C.

¹H-NMR (400 MHz, CDCl₃): δ=2.04 (s, 3H), 2.05 (s, 3H), 2.06 (s, 3H), 2.08 (s, 3H), 3.34 (d, J=6.7 Hz, 2H), 3.84 (ddd, 2.4, 5.3, 10.0 Hz, 1H), 4.17 (dd, J=2.4, 12.2 Hz, 1H), 4.28 (dd, J=5.3, 12.2 Hz, 1H), 5.93 (m, 1H), 5.03-5.09 (m, 3H), 5.17 (m, 1H), 5.23-5.32 (m, 2H), 6.91-6.94 (m, 2H), 7.09-7.13 (m, 2H).

¹³C-NMR (100 MHz, CDCl₃): δ=20.6, 20.6, 20.7, 20.7 (CH₃), 39.4, 62.0 (CH₂), 68.3, 71.2, 72.0, 72.8, 99.4 (CH), 115.8 (2×CH), 117.1 (CH₂), 129.6 (2×CH₂), 135.1 (C), 137.4 (CH), 155.3, 169.4, 169.5, 170.3, 170.7 (C).

### Chavicol β-D-glucopyranoside, compound 1

A mixture of 4.5 g of 2,3,4,6-tetra-O-acetyl-β-D-glucopyranosyl-4-allylbenzene (9.2 mmol), 25 mg of lithium hydroxide and 75 ml of methanol is stirred for 24 hours at room temperature. The solvent is distilled off in vacuo and the crude product is purified by preparative HPLC. Approximately 1.07 g of chavicol β-D-glucopyranoside 1 (D-glucopyranosyl-4-allylbenzene) are obtained.

HPLCMS (C18, 0.2 ml/min, H₂O/HCOOH/acetonitrile 80:20 to 0:100 in 35 min, APCl—); RT 9.3 min, m/z=341.1 (100%, [(M+HCOOH)—H]⁻).

¹H-NMR (400 MHz, d₆-DMSO): δ=7.09 (2H, m, H-3, 5), 6.96 (2H, m, H-2, 6), 5.93 (1H, ddt, J=17 Hz, J=10.1 Hz, J=6.8 Hz, H-8), 5.28 (1H exchangeable, d, J=4.9 Hz, OH), 5.04 (2H, ddt, J=17 Hz, J=2.1 Hz, J=1.6 Hz, H-8a), 5.02 (1H, ddt, J=10.1 Hz, J=2.2 Hz, J=1.3 Hz, H-8b), 4.80 (1H, d, J==7.4 Hz, H-1′), 4.56 (1H exchangeable, dd, J=6.2 Hz, 5.3 Hz, OH), 3.68 (1H, ddd, J=11.8 Hz, J=5.3 Hz, J=2.1 Hz, H-6′a), 3.48-3.42 (1H, m, H-6′b), 3.39-3.20 (m) ppm.

¹³C-NMR (100 MHz, d₆-DMSO): δ=155.72 (C, C-1), 137.92 (CH, C-7), 132.80 (C, C-4), 129.16 (2×CH, C-3, C-5), 116.16 (2×CH, C-2, C-6), 115.36 (CH₂, C-9), 100.47 (CH, C-1′) 76.91 (CH, C-5′), 76.54 (C, C-3′), 73.15 (CH, C-2′), 69.65 (CH, C-4′), 60.62 (CH₂, C-6′) ppm.

### Chavicol β-D-glucopyranoside,

### Compound 1, Alternative Synthesis Via the β-trichloroacetimidate A

Tetra-O-acetyl-β-D-glucopyranosyl-1-O-trichloroacetimidate (compound A, prepared according to R. R. Schmidt, J. Michel, M. Roos, Liebigs Ann. Chem. 1984, 1343-1357; 21.9 g, 50 mmol) is placed in dichloromethane (400 ml), under nitrogen, with chavicol (4-allylphenol, compound B, 7.2 g, 55 mmol), and 25 g of powdered activated molecular sieve (pore size 40 nm) are added. The reaction mixture is cooled to −50° C., and BF₃ diethyl etherate (1.99 g, 10 mmol) is metered in under protecting gas, with the aid of a syringe/cannula, in the course of one hour. The mixture is then allowed to warm to room temperature, the molecular sieve is filtered off, the residue is washed with a small amount of dichloromethane, and the organic phase is washed with saturated NaHCO₃ solution, dried over Na₂SO₄, filtered and concentrated in vacuo. The crystalline crude product (28 g) is stirred in ethanol (60 ml) for 30 minutes to complete the reaction; after storage at 5° C., filtration is carried out and compound C, in the form of a colourless crystalline mass, is dried (18.0 g, 78% of theory). Compound C (17.9 g, 38.6 mmol) is dissolved in methanol (50 ml), and lithium hydroxide (100 mg) is added. The mixture is stirred for a total of 24 hours and then concentrated by evaporation in vacuo. 15.5 g of crude product are obtained, which is recrystallised from methanol at elevated temperature. Chavicol β-D-glucopyranoside (compound 1) is obtained in the form of colourless needle-like crystals.

Yield: 10.9 g (37 mmol, 74% of theory, based on compound A)

### Application Example 1

### Enhancement of the Sweet Impression of a Model Application Containing Sucrose

Sensory profile of 100 ppm of chavicol β-D-glucopyranoside (compound 1 from Example 1) in 5 wt. % aqueous sugar solution (sucrose): slightly dusty-dry, otherwise neutral.

Sensory profile of 100 ppm of chavicol β-D-glucopyranoside (compound 1 from Example 1) in aqueous solution: virtually neutral, slightly dusty-dry.

Comparison: sensory profile of 2 ppm of chavicol (compound B from Example 1) in 5 wt. % aqueous sugar solution (sucrose): cresol note, rubber, unpleasant

In order to quantify the enhancement of a sweet impression by addition of the propenylphenyl glycosides to be used according to the invention, the sweetness of sucrose-containing yoghurt (0.5% fat content) and of samples containing the same amount of sucrose and in addition a specific concentration of the propenylphenyl glycosides of formula (I) to be used according to the invention was determined by a group of experts (rating 1 [extremely slightly sweet] to 10 [extremely sweet]). Evaluation was carried out by calculating the enhancement (in %) of the sweetness impression from the average values of the assessments of the yoghurts containing sucrose (a) or sucrose and propenylphenyl glycoside (b).

| Substance, | | | | |
|---|---|---|---|---|
| concen- | | | | |
| tration | | | | % Enhancement |
| in yoghurt | Sweet-tasting | Sweetness impression | | of the |
| (0.5% fat | substance, | (1-10) | | sweetness |
| content) | concentration | a) without | b) with | impression |
| compound 1, | sucrose, 5% | 3.9 ± 1.1 | 4.9 ± 1.4 | +24% |
| 200 ppm | | | | (16/10), p < 0.05 |

Chavicol as such was not tested analogously, because the intrinsic flavour impression was very strong and disruptive even at 2 ppm, and this compound therefore proved to be unusable for the sweetness-enhancing effect. Tasting of an equivalent amount of glucose (200 ppm, corresponding to 0.02 wt. %) was not carried out, because corresponding absolute amounts or amounts added to the sucrose already present have no sensory relevance.

### Application Example 2

### Spray-Dried Preparations as Semi-Finished Products for Flavouring Finished Products

| | Preparation (amount in wt. %) | | | | | | |
|---|---|---|---|---|---|---|---|
| Ingredient | A | B | C | D | E | F | G |
| Drinking water | 60.8% | 60.8% | 60.8% | 60.8% | 60.8% | 60.8% | 60.8% |
| Maltodextrin | 24.3% | 24.3% | 24.3% | 24.3% | 24.3% | 24.3% | 24.3% |
| from wheat | | | | | | | |
| Gum arabic | 6.1% | 6.1% | 6.1% | 6.1% | 6.1% | 6.1% | 6.1% |
| Compound 1 | 8.8% | 4.4% | 4.4% | 2.2% | 4.4% | 5.5% | 1.1% |
| Phloretin | — | 4.4% | — | 2.2% | 2.2% | 1.1% | 3.3% |
| Hesperetin | — | — | 4.4% | 4.4% | 2.2% | 2.2% | 4.4% |

The drinking water is placed in a container and the maltodextrin and the gum arabic are dissolved therein. The propenylphenyl glycosides to be used according to the invention, and other constituents, are then emulsified into the above-described carrier solution using a mixer (Turrax). The temperature of the resulting mixture should not exceed 30° C. The mixture is then spray-dried (desired inlet temperature: 185-195° C., desired outlet temperature: 70-75° C.). The spray-dried finished product contains about 18 to 22% of compound 1 to be used according to the invention, semi-finished products B to G contain corresponding total amounts of compound 1, phloretin and hesperitin.

Spray-dried preparations containing other propenylphenyl glycosides to be used according to the invention can be prepared in an analogous manner.

### Application Example 3

### Spray-Dried Preparation as Semi-Finished Product for Flavouring Finished Products Using Further Taste-Modulating Substances

| | Preparation (amount in wt. %) | | | | | | | |
|---|---|---|---|---|---|---|---|---|
| Ingredient | A | B | C | D | E | F | G | H |
| Drinking water | 60.8 | 60.8 | 60.8 | 60.8 | 60.8 | 60.8 | 60.8 | 60.8 |
| Maltodextrin from wheat | 24.3 | 24.3 | 24.3 | 24.3 | 24.3 | 24.3 | 24.3 | 24.3 |
| Gum arabic | 6.1 | 6.1 | 6.1 | 6.1 | 6.1 | 6.1 | 6.1 | 6.1 |
| Compound 1 | 4.4 | 2.2 | 4.4 | 6.4 | 3.2 | 4.4 | 4.4 | 4.4 |
| Phloretin | | | 2.0 | | 3.2 | | | |
| Hesperetin | | 2.2 | | | | | | |
| gamma-aminobutyric acid | 4.4 | 4.4 | 2.4 | | | | | |
| Homoeriodictyol | | | | 2.4 | 2.4 | | | |
| Divanillin | | | | | | 4.4 | | |
| 2,4-Dihydroxybenzoic acid N- | | | | | | | 2.2 | |
| (4-hydroxy-3-methoxybenzyl)- | | | | | | | | |
| amide | | | | | | | | |
| 6-(4-Hydroxy-3-methoxy- | | | | | | | 2.2 | |
| phenyl)-hexane-2,4-dione | | | | | | | | |
| Diacetyl trimer of formula | | | | | | | | 4.4 |
| 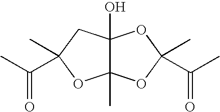 | | | | | | | | |

The drinking water is placed in a container, and the maltodextrin and the gum arabic are dissolved therein. The flavourings are then emulsified into the carrier solution using a mixer (Turrax). The temperature of the resulting mixture should not exceed 30° C. The mixture is then spray-dried (desired inlet temperature: 185-195° C., desired outlet temperature: 70-75° C.). The spray-dried finished product contains about 18 to 22% flavourings.

### Application Example 4

### Combinations with Sweet-Tasting Substances as Sweeteners

| | Preparation (amount in wt. %) | | | | | | | |
|---|---|---|---|---|---|---|---|---|
| Ingredient | A | B | C | D | E | F | G | H |
| Sucrose | 89.9 | 89.9 | 89.9 | 89.9 | | | | 50 |
| Fructose | 10 | 10 | 10 | | | | | |
| Tagatose | | | | 10 | | | | |
| High fructose | | | | | | 99.9 | | |
| corn syrup | | | | | | | | |
| Maltitol | | | | | 79.9 | | 99 | |
| Sorbitol | | | | | 10.0 | | | 49.95 |
| Compound 1 | 0.1 | 0.05 | 0.05 | | | 0.05 | | 0.025 |
| Phloretin | | 0.05 | | | | 0.05 | | 0.025 |
| Hesperetin | | | 0.05 | | | | | |
| Compound 1 | | | | 0.5 | 0.5 | | 1 | |
| in the form | | | | | | | | |
| of a spray- | | | | | | | | |
| dried | | | | | | | | |
| preparation | | | | | | | | |
| (preparation | | | | | | | | |
| A from | | | | | | | | |
| Application | | | | | | | | |
| Example 2) | | | | | | | | |

The ingredients are mixed in the indicated sequence. The resulting product can be used as a sweetener for foods or enjoyment foods, e.g. coffee or tea.

As an example of its use, tea and the product are mixed and packed into tea bags made of filter paper. For use, 100-250 ml of boiling water are poured onto a tea bag and allowed to brew for 2-5 minutes.

### Application Example 5

### Flavouring Mixtures for Enhancing Sweetness

| | Preparation (amount in wt. %) | | | | | | | | | |
|---|---|---|---|---|---|---|---|---|---|---|
| Ingredient | A | B | C | D | E | F | G | H | I | J |
| Vanilla flavouring | 75.00 | | 75.00 | | | | | | | |
| (e.g. obtainable | | | | | | | | | | |
| from Symrise) | | | | | | | | | | |
| Sugar flavouring, | | 2.00 | | | | | | | | |
| black treacle type | | | | | | | | | | |
| Ethyl lactate | | | | 1.00 | 0.50 | 0.050 | | 0.50 | 1.00 | 0.05 |
| n-Propyl lactate | | | | 0.50 | | | | 0.50 | 0.50 | |
| n-Butyl lactate | | | | 0.30 | 0.30 | 0.030 | 1.80 | 0.30 | 0.30 | 0.03 |
| Diethyl malate | | | | 1.00 | | | 1.00 | 0.50 | 1.00 | |
| Diethyl tartrate | | | | 0.50 | | | | 0.50 | 0.50 | |
| Diethyl succinate | | | | 0.50 | | | | | 0.50 | 10.0 |
| Diethyl malonate | | | | 0.50 | | | 2.00 | | 0.50 | |
| Triethyl citrate | | | | 0.50 | | | | 0.50 | 0.50 | |
| Lactic acid | | | | 1.00 | 2.00 | 0.20 | 2.00 | | 2.00 | 0.20 |
| Hesperetin | | | 0.30 | | 1.25 | | 1.25 | | 0.50 | 2.50 |
| Compound 1 | 0.625 | 1.00 | 0.325 | 2.50 | 1.25 | 2.50 | 1.25 | 5.00 | 0.30 | 2.50 |
| Phloretin | | 1.45 | | | | | | | 0.30 | |
| Hesperetin | | | | | | | | | 0.40 | |
| 1,2-Propylene | ad | ad | ad | ad | ad | ad | ad | ad | ad | ad |
| glycol | 100 | 100 | 100 | 100 | 100 | 100 | 100 | 100 | 100 | 100 |

The components indicated in the table are mixed in the indicated sequence, by stirring, and are optionally homogenised completely by heating at 20-50° C. Clear, mostly colourless or yellowish solutions are obtained, which can be used as flavourings.

### Application Example 6

### Chewing Gums

### Application Example 6a

| Part | Ingredient | Amount in wt. % |
|---|---|---|
| A | Chewing gum base, Company “Jagum T” | 30.00 |
| B | Sorbitol, powdered | 39.00 |
| | Isomalt ® (Palatinit GmbH) | 9.50 |
| | Xylitol | 2.00 |
| | Mannitol | 3.00 |
| | Aspartame ® | 0.10 |
| | Acesulfame ® K | 0.10 |
| | Emulgum ® (Colloides Naturels, Inc.) | 0.30 |
| C | Sorbitol, 70% aqueous solution | 14.00 |
| | Glycerol | 1.00 |
| D | Peppermint flavouring, containing 1 wt. % | 1.00 |
| | compound 1, based on the total weight of the | |
| | flavouring | |

Parts A to D are mixed and kneaded intensively. The crude mass can be processed, for example, in the form of thin strips to give chewing gum that is ready for consumption.

### Application Example 6b

### Non-Stick Chewing Gum

The chewing gum base K1 consisted of 2.0% butyl rubber (isobutene-isoprene copolymer, MW 400,000), 6.0% polyisobutene (MW=43,800), 43.5% polyvinyl acetate (MW=12,000), 31.5% polyvinyl acetate (MW=47,000), 6.75% triacetin and 10.25% calcium carbonate. Production of the chewing gum base K1 and of the chewing gum can be carried out analogously to U.S. Pat. No. 5,601,858.

| | I (wt. %) | II (wt. %) | III (wt. % |
|---|---|---|---|
| Chewing gum base K1 | 26.00 | 26.00 | 26.00 |
| Triacetin | 0.25 | 0.25 | 0.25 |
| Lecithin | 0.50 | 0.50 | 0.50 |
| Sorbitol, crystalline | 40.90 | 40.60 | 40.50 |
| Mannitol | 15.30 | 15.20 | 15.10 |
| Glycerol | 12.10 | 12.00 | 11.80 |
| Aspartame | 0.17 | 0.17 | 0.17 |
| Encapuslated aspartame | 1.08 | 1.08 | 1.08 |
| Amorphous silica | 1.00 | 1.00 | 1.00 |
| Cottonseed oil | 0.50 | 0.50 | 0.50 |
| Polyoxyethylene sorbitan | 1.00 | 1.00 | 1.00 |
| monolaurate (E-432) | | | |
| Encapsulated spearmint flavouring | 0.20 | 0.10 | 0.30 |
| (contains L-carvone) | | | |
| Encapuslated wintergreen | — | 0.40 | — |
| flavouring (contains methyl | | | |
| salicylate) | | | |
| Peppermint oil, containing 1 wt. % | 1.00 | 1.20 | 1.50 |
| compound 1, based on the total | | | |
| weight of the flavouring | | | |
| L-menthyl L-lactate | 0.10 | — | 0.30 |

### Application Example 6c

### Bubble Gum

The bubble gums can be produced analogously to U.S. Pat. No. 5,093,136

| | I (wt. %) | II (wt. %) |
|---|---|---|
| Styrene-butadiene copolymer (SBR) | 19.50 | 17.50 |
| Polyisobutene | 8.00 | 8.00 |
| Sorbitol powder | 49.19 | 47.19 |
| Sorbitol, 70% in water | 9.20 | 22.20 |
| Hydrogenated starch hydrolysate (HSH) | 9.00 | — |
| Glycerol | 3.00 | 2.00 |
| Aspartame | 0.10 | 0.10 |
| Encapsulated aspartame | 0.50 | 0.50 |
| Red and blue colouring | 0.01 | 0.01 |
| Strawberry/raspberry flavouring, | 1.50 | 2.50 |
| containing 1% compound 1, based on | | |
| the total weight of the flavouring | | |

The chewing gums of formulation (I) were formed into compact spheres, those of formulation (II) into hollow spheres.

### Application Example 6d

### Chewing Gum

Chewing gum base K2 consisted of 28.5% terpene resin, 33.9% polyvinyl acetate (MW=14,000), 16.25% hydrogenated vegetable oil, 5.5% mono- and di-glycerides, 0.5% polyisobutene (MW=75,000), 2.0% butyl rubber (isobutene-isoprene copolymer), 4.6% amorphous silica (water content about 2.5%), 0.05% antioxidant tert-butylhydroxytoluene (BHT), 0.2% lecithin and 8.5% calcium carbonate. The production of the chewing gum base K2 and of the chewing gums can be carried out analogously to U.S. Pat. No. 6,986,907.

| | I (wt. %) | II (wt. %) | III (wt. % |
|---|---|---|---|
| Chewing gum base K2 | 25.30 | 27.30 | 26.30 |
| Sorbitol | 61.48 | 59.48 | 61.60 |
| Glycerol | 2.40 | 2.40 | 2.40 |
| Lecithin | 7.00 | 7.00 | 7.00 |
| Aspartame | 0.14 | 0.14 | 0.14 |
| Encapsulated aspartame | 0.68 | 0.68 | 0.48 |
| Menthol, spray-dried | 1.00 | 0.50 | 0.40 |
| Cherry flavouring, spray-dried | — | 1.20 | — |
| Lemon flavouring, containing 1 wt. | 1.20 | 1.30 | 1.68 |
| % compound 1, based on the | | | |
| total weight of the flavouring | | | |
| Orange oil, natural | 0.80 | — | — |

The chewing gums of formulations (I) and (II) were formed into strips, those of formulation (III) into pellets.

### Application Example 7

### Toothpaste

| Part | Ingredient | Amount in wt. % |
|---|---|---|
| A | Demineralised water | 22.00 |
| | Sorbitol, 70% aqueous solution | 45.00 |
| | Solbrol ® M, sodium salt (Bayer AG, | 0.15 |
| | p-hydroxy-benzoic acid alkyl ester) | |
| | Trisodium phosphate | 0.10 |
| | Saccharin, 450 times | 0.20 |
| | Sodium monofluorophosphate | 1.12 |
| | Polyethylene glycol 1500 | 5.00 |
| B | Sident 9 (abrasive silicon dioxide) | 10.00 |
| | Sident 22 S (thickening silicon dioxide) | 8.00 |
| | Sodium carboxymethylcellulose | 0.90 |
| | Titanium dioxide | 0.50 |
| C | Demineralised water | 4.53 |
| | Sodium lauryl sulfate | 1.50 |
| D | Peppermint flavouring, containing 1% | 1.00 |
| | compound 1, based on the total weight of the | |
| | flavouring | |

The ingredients of parts A and B are pre-mixed separately, and the parts are then thoroughly stirred together in vacuo for 30 minutes at 25-30° C. Part C is pre-mixed and added to A and B; D is added, and the mixture is stirred thoroughly in vacuo for 30 minutes at 25-30° C. After pressure relief, the toothpaste is finished and can be introduced into containers.

### Application Example 8

### Reduced-Sugar Refreshing Drinks

Comparison Preparation with normal sucrose content (A)
Comparison preparation with reduced sucrose content (B)

| Preparations | | | | | | | | |
|---|---|---|---|---|---|---|---|---|
| according | | | | | | | | |
| to the | | | | | | | | |
| invention | | | | | | | | |
| (C—H) | Preparation (amount in wt. %) | | | | | | | |
| Ingredient | A | B | C | D | E | F | G | H |
| Water | 89.85 | 91.85 | 91.78 | 91.787 | 91.289 | 91.594 | 91.490 | 91.289 |
| Sucrose | 10.0 | 8.0 | 8.0 | 8.0 | 8.0 | 8.0 | 8.0 | 8.0 |
| Citric acid | 0.15 | 0.2 | 0.2 | 0.2 | 0.2 | 0.2 | 0.2 | 0.2 |
| Fructose | | | | | | 0.2 | | |
| Tagatose | | | | | | | 0.3 | |
| Maltitol syrup | | | | | 0.5 | | | |
| Erythritol | | | | | | | | 0.5 |
| Compound 1 | — | — | 0.020 | 0.0100 | 0.0100 | 0.0050 | 0.0100 | 0.0100 |
| Phloretin | — | — | — | 0.0030 | 0.0005 | 0.0005 | | 0.0005 |
| Hesperetin | — | — | — | — | 0.0005 | 0.0005 | | 0.0005 |

The substances were placed in a vessel; water was introduced, and the substances were dissolved.

### Application Example 9

### Use in a Reduced-Sugar Refreshing Drink Together with Other Flavourings and Taste-Imparting Substances

| | | Preparation | | | | | | | |
|---|---|---|---|---|---|---|---|---|---|
| Ingredient | Content | A | B | C | D | E | F | G | H |
| Saccharose | % | 8 | 8 | 8 | 8 | 8 | 8 | 8 | 8 |
| Citric acid | % | 0.2 | 0.2 | 0.2 | 0.2 | 0.2 | 0.2 | 0.2 | 0.2 |
| Compound 1,1% in 1,2- | % | 0.05 | 0.05 | 0.05 | 0.05 | 0.1 | 0.1 | 0.1 | 0.1 |
| propylene glycol | | | | | | | | | |
| Hesperetin, 1% in 1,2- | % | — | 0.025 | 0.05 | 0.025 | — | 0.05 | 0.05 | 0.05 |
| propylene glycol | | | | | | | | | |
| Phloretin, 1% in 1,2- | % | 0.05 | 0.025 | — | 0.025 | 0.1 | — | 0.1 | 0.15 |
| propylene glycol | | | | | | | | | |
| Ethylhydroxymethyl- | ppb | 0.01 | | | | | | | |
| furanone | | | | | | | | | |
| Vanillin | ppb | 15 | | | | | | | |
| Diethyl malonate | ppb | | 70 | | | | | | |
| Phenylethyl acetate | ppb | | 1 | | | | | | |
| 2-Methylbutanal | ppb | | | 0.3 | | 0.3 | | | |
| Isovaleraldehyde | ppb | | | 0.2 | | 0.2 | | | |
| Furfuryl acetate | ppb | | | 0.3 | | | | | |
| Massollactone | ppb | | | | 5 | 5 | | 5 | 5 |
| γ-Octalactone | ppb | | | | 5 | 5 | | 5 | 5 |
| Ethyl butyrate | ppb | | | 0.5 | | 0.5 | | 0.5 | |
| Maltol | ppb | 350 | | | | 350 | | 350 | |
| 2,5-Dimethyl-4-hydroxy- | ppb | 3 | | | | 3 | | 3 | |
| 2H-furan-3-one | | | | | | | | | |
| Ethyl isobutyrate | ppb | | 0.1 | | | 0.1 | | 0.1 | |
| Ethyl-2-methyl butyrate | ppb | | 0.1 | | | 0.1 | | 0.1 | |
| 1,2-Propylene glycol | % | 0.1 | 0.1 | 0.1 | 0.1 | 0.1 | 0.1 | 0.1 | 0.1 |
| Butylphenyl acetate | ppb | | | | | 10 | | | |
| Acetanisole | ppb | | | | | 20 | | | |
| Methyl sorbate | ppb | | | | | 100 | | | |
| L-Lysine | ppm | | | | | | 100 | 30 | |
| Malic acid | ppm | | | | | | 80 | | |
| L-Arginine | ppm | | | | | | 5 | 20 | |
| L-Aspartic acid | ppm | | | | | | 0.5 | | |
| Calcium chloride | ppm | | | | | | 20 | | |
| Glutamine | ppm | | | | | | 2 | | |
| Potassium hydrogen | ppm | | | | | | 6 | | |
| phosphate | | | | | | | | | |
| Magnesium chloride | ppm | | | | | | 20 | | |
| L-Valine | ppm | | | | | | 0.5 | | |
| Glycine | ppm | | | | | | | 40 | |
| L-Alanine | ppm | | | | | | | 20 | |
| L-Serine | | | | | | | | 50 | |

| | |
|---|---|
| Water | make up to 100% |

The substances were placed in a vessel and made up to 100% with water and dissolved. If required, the product was introduced into bottles and carbonated.

### Application Example 10

### Sugar-Free Hard Caramels

| Ingredient | Content (%) |
|---|---|
| Palatinite, type M | 75.10% |
| Water | 24.82% |
| Peppermint flavouring | 0.1% |
| Compound 1 | 0.025% |

Palatinite was mixed with water and the mixture was melted at 165° C. and then cooled to 115° C. The peppermint flavouring and compound 1 were added and, after thorough mixing, the mixture was poured into moulds, removed from the moulds after it had solidified and then packed individually.

### Application Example 11

### Low-Fat Yoghurts

Comparison preparation with sugar (A)
Comparison preparation with reduced sugar content (A)
Preparations according to the invention with reduced sugar content and compound 1 (C)
Comparison preparation with reduced sugar content and hesperetin (D)

Preparation (amounts in wt. %)

| Ingredient | A | B | C | D |
|---|---|---|---|---|
| Sucrose | 10% | 8% | 8% | 8% |
| Tagatose | — | — | — | — |
| Fructose | — | — | — | — |
| Compound 1 | — | — | 0.015% | — |
| Hesperetin | — | — | — | 0.01% |
| Yoghurt, 0.1% fat | make | make | make | make |
| | up to | up to | up to | up to |
| | 100% | 100% | 100% | 100% |
| Reduction in sweetness | — | −42% | −23% | −29% |
| as compared with A (16 | | | | |
| panellists, duo test) | | | | |

The ingredients were mixed and cooled at 5° C.

The sensory test showed that the loss of sweetness as a result of sugar reduction (comparison A with B) can for the most part only be compensated for (comparison A with C) with compound 1, hesperetin alone produces less good results.

### Application Example 12

### Use Together with Sweeteners in Low-Fat Yoghurts

Comparison preparation with sweetener mixture (A)
Preparations according to the invention with sweetener mixture and propenylphenyl glycosides (B-D)

| | Preparation (amounts in wt. %) | | | |
|---|---|---|---|---|
| Ingredient | A | B | C | D |
| D-Tagatose | 0.482% | 0.482% | 0.482% | 0.482% |
| Sucralose | 0.003% | 0.003% | 0.003% | 0.003% |
| Aspartame | 0.005% | 0.005% | 0.005% | 0.005% |
| Acesulfame K | 0.01% | 0.01% | 0.01% | 0.01% |
| Compound 1 | — | 0.01% | 0.005% | 0.005% |
| Phloretin | — | — | 0.005% | — |
| Hesperetin | — | — | — | 0.005% |
| Yoghurt, 0.1% | make up to | make up to | make up to | make up to |
| fat | 100% | 100% | 100% | 100% |

The ingredients were mixed and cooled at 5° C.

### Application Example 13

### Milkshakes

Comparison preparations with sugar (A-B)
Preparations according to the invention with sugar and propenylphenyl glycosides (C-E)

| | Preparation (amounts in wt. %) | | | | |
|---|---|---|---|---|---|
| Ingredient | A | B | C | D | E |
| Sucrose | 10.0 | 8.0 | 8.0 | 8.0 | 7.0 |
| Fructose | — | — | — | — | 0.5 |
| Tagatose | — | — | — | — | 0.5 |
| Compound 1 | — | — | 0.02% | 0.015% | 0.015% |
| Phloretin | — | — | — | 0.005% | — |
| Hesperetin | — | — | — | — | 0.005% |

| | |
|---|---|
| Long-life milk, 1.5% fat | make up to 100% |

The ingredients were mixed, made up with milk, stirred thoroughly, introduced into bottles and stored cool at 5° C.

### Application Example 14

### Reduced-Sugar Tomato Ketchup

Comparison preparation with sugar (A)
Comparison preparation with reduced sugar content (B)
Preparations according to the invention with sugar and propenylphenyl glycosides (C-I)

| | Preparation (amounts in wt. %) | | | | | | | |
|---|---|---|---|---|---|---|---|---|
| Ingredient | A | B | C | E | F | G | H | I |
| Sodium | 2 | 2 | 2 | 2 | 2 | 2 | 2 | 2 |
| chloride | | | | | | | | |
| Starch, | 1 | 1 | 1 | 1 | 1 | 1 | 1 | 1 |
| Farinex WM 55 | | | | | | | | |
| Sucrose | 12 | 9.6 | 9.2 | 8.4 | 9.6 | 9.6 | 8.4 | 8.4 |
| 2x tomato | 40 | 40 | 40 | 40 | 30 | 30 | 30 | 30 |
| concentrate | | | | | | | | |
| Glucose syrup | 18 | 18 | 18 | 18 | 18 | 18 | 18 | 18 |
| 80 Brix | | | | | | | | |
| Brandy vinegar | 7 | 7 | 7 | 7 | 3 | 3 | 3 | 3 |
| 10% | | | | | | | | |
| Water | 20 | 22.4 | 22.4 | 23.2 | 36.0 | 36.0 | 37.2 | 37.2 |
| Compound 1, | | | 0.4 | 0.2 | 0.2 | 0.4 | 0.2 | 0.2 |
| 2.5% in 1,2- | | | | | | | | |
| propylene | | | | | | | | |
| glycol | | | | | | | | |
| Phloretin, 2.5% in | | | | | | | 0.2 | |
| 1,2-propylene | | | | | | | | |
| glycol | | | | | | | | |
| Hesperetin, 2.5% | | | | 0.2 | 0.2 | | | 0.2 |
| in 1,2-propylene | | | | | | | | |
| glycol | | | | | | | | |

The ingredients are mixed in the indicated sequence and the finished ketchup is homogenised with the aid of a stirring device, introduced into bottles and sterilised.

### Application Example 15

### Reduced-Sugar Ice Cream

Comparison preparation with sugar (A)
Comparison preparation with reduced sugar content (B)

Preparations according to the invention with sugar and propenylphenyl glycosides (C-F)

| | Preparation (content in wt. %) | | | | | |
|---|---|---|---|---|---|---|
| Ingredient | A | B | C | D | E | F |
| Skimmed milk | 57.15 | 61.15 | 60.95 | 61.05 | 60.95 | 61.05 |
| Vegetable fat, melting range | 20.00 | 20.00 | 20.00 | 20.00 | 20.00 | 20.00 |
| 35-40° C. | | | | | | |
| Sugar (saccharose) | 12.00 | 8.00 | 8.00 | 8.00 | 8.00 | 8.00 |
| Skimmed milk powder | 5.00 | 5.00 | 5.00 | 5.00 | 5.00 | 5.00 |
| Glucose syrup 72% dry | 5.00 | 5.00 | 5.00 | 5.00 | 5.00 | 5.00 |
| substance | | | | | | |
| Emulsifier SE 30 (Grindstedt | 0.65 | 0.65 | 0.65 | 0.65 | 0.65 | 0.65 |
| Products, Denmark) | | | | | | |
| Flavouring containing 0.1% | 0.20 | 0.20 | 0.20 | 0.20 | | |
| diacetyl and 1% vanillin | | | | | | |
| Flavouring containing 0.1% | | | | | 0.20 | 0.20 |
| diacetyl trimer (for formula | | | | | | |
| see Application Example 3), | | | | | | |
| 0.1% diacetyl and 1% | | | | | | |
| vanillin | | | | | | |
| Flavouring according to | | | 0.20 | | 0.20 | |
| Application Example 5, | | | | | | |
| preparation E | | | | | | |
| Flavouring according to | | | | 0.10 | | 0.10 |
| Application Example 5, | | | | | | |
| preparation H | | | | | | |

Skimmed milk and glucose syrup were heated to 55°, and sugar, skimmed milk powder and emulsifier were added. The vegetable fat was pre-heated, and the entire mixture was heated to 58° C. After addition of the flavouring, homogenisation was carried out by means of a continuous-flow high-pressure homogeniser (180/50 bar). The resulting mixture was subjected to heat treatment for one minute at 78° C. and then cooled to 2-4° C. and incubated for 10 hours at that temperature for maturation. The matured mass was then introduced into containers and stored frozen at −18° C.

### Application Example 16

### Ice Cream Suitable for Diabetics

An ice cream suitable for diabetics was produced from the following ingredients and introduced into beakers in portions of 95 ml:

Thickened skimmed milk, fructose syrup, strawberry pieces, strawberry purée (15%), vegetable fat, diet chocolate pieces (3.5%, with emulsifier soya lecithin), whey product, beetroot juice, locust bean flour, guar flour, carrageenan, emulsifier (E 471), gelatin, acidifying agent citric acid, strawberry flavouring (containing 2.5 wt. % compound 1, based on the total weight of the strawberry flavouring), colouring carotene.

Nutritional value (per 95 ml):

protein 1.8 g, carbohydrate 13.3 g (of which fructose 9.5 g), fat 4.2 g.

### Application Example 17

### Diet Chocolate Based on Maltite

A chocolate suitable for diabetics was produced from the following ingredients and poured into rectangular slabs:

maltite, hazelnut mass, cocoa butter, skimmed milk powder, cocoa mass, inulin, concentrated butter, emulsifier soya lecithin, vanilla flavouring (containing vanilla pod extract, vanillin, 2 wt. % compound 1 and 1 wt. % phloretin, based on the total weight of the vanilla flavouring).

Nutritional value (per 100 g):

protein 8 g, carbohydrate 43 g (of which maltite 34 g), fat 34 g.

### Application Example 18

### Diet Chocolate Based on Fructose

A chocolate suitable for diabetics was produced from the following ingredients and poured into rectangular slabs:

cocoa mass, fructose, skimmed milk powder, cocoa butter, inulin, concentrated butter, emulsifier soya lecithin, walnuts, cooking salt, vanilla flavouring (containing vanillin and 2 wt. % compound 1, based on the total weight of the vanilla flavouring).

Nutritional value (per 100 g):

protein 8.8 g, carbohydrate 34 g (of which fructose 23 g, lactose 7.5 g, saccharose 1.4 g), fat 36 g; fibre 18.5 (of which 12.2 g inulin); sodium: 0.10 g. Cocoa content at least 50 wt. %.

### Application Example 19

### Reduced-Sugar Muesli Mixture

| No. | | A (wt. %) | B (wt. %) |
|---|---|---|---|
| 1 | Rolled oats | 17.00 | 18.60 |
| 2 | Crispy rolled oat clusters | 10.00 | 12.00 |
| 3 | Rice Krispies | 16.90 | 17.70 |
| 4 | Cornflakes | 16.50 | 17.40 |
| 5 | Currants | 3.50 | 3.50 |
| 6 | Hazelnuts, chopped | 2.50 | 2.50 |
| 7 | Glucose syrup from wheat, DE 30 | 9.50 | 9.50 |
| 8 | Saccharose | 20.00 | 14.00 |
| 9 | Water | 4.00 | 4.00 |
| 10 | Citric acid powder, anhydrous | 0.10 | 0.10 |
| 11 | Compound 1, 2.5% in 1,2-propylene | — | 0.40 |
| | glycol | | |

Each of constituents nos. 1 to 6 are mixed in a rotary drum (mix 1). Each of constituents nos. 7 to 9 are heated and constituent no. 10 is added (as well as, in formulation B, additionally constituent no. 11) (mix 2). Mix 2 is added to mix 1, and thorough mixing is carried out. Finally, the resulting muesli mixture is placed on a baking sheet and dried in an oven at 130° C. for 8 minutes.

### Application Example 20

### Reduced-Sugar Fruit Gums

A group of experts rated the perception of sweetness of the full-sugar fruit gums of formulation A below and the reduced-sugar fruit gums of formulation B (the amount of saccharose was reduced by 76%) as equally strong in both cases. In a triangular test which was additionally carried out, no difference in the sweetness impression was found.

| | A (wt. %) | B (wt. %) |
|---|---|---|
| Water | 23.70 | 25.60 |
| Saccharose | 34.50 | 8.20 |
| Glucose syrup, DE 40 | 31.89 | 30.09 |
| Iso Syrup C* Tru Sweet 01750 (Cerestar GmbH) | 1.50 | 2.10 |
| Gelatin 240 Bloom | 8.20 | 9.40 |
| Polydextrose (Litesse ® Ultra, Danisco Cultor | — | 24.40 |
| GmbH) | | |
| Yellow and red colouring | 0.01 | 0.01 |
| Citric acid | 0.20 | |
| Flavouring according to Application Example 5, | — | 0.20 |
| preparation F | | |

Polydextrose is a polysaccharide which is not itself sweet-tasting, with a low calorific value.

### Application Example 21

### Chocolate-Cappuccino Ice Cream

A group of experts rated the perception of sweetness of the full-sugar ice cream of formulation A below and the reduced-sugar ice cream of formulation B (the amount of saccharose was reduced by 25%) as equally strong in both cases. In a triangular test which was additionally carried out, no difference in the sweetness impression was found.

| | A (wt. %) | B (wt. %) |
|---|---|---|
| Glucose-fructose syrup | 14.10 | 14.10 |
| Saccharose | 10.00 | 7.50 |
| Skimmed milk powder | 5.00 | 5.00 |
| Cream (36% fat content) | 24.00 | 24.00 |
| Emulsifier and stabiliser | 0.50 | 0.50 |
| Cremodan ® 709VEG (Danisco) | | |
| Cocoa powder | 5.975 | 5.975 |
| Carrageenan | 0.025 | 0.025 |
| Water | 40.20 | 42.30 |
| Cappucino flavouring | 0.20 | 0.20 |
| Compound 1, 2.5% in 1,2-propylene | — | 0.40 |
| glycol/ethanol | | |

### Application Example 23

### Gelatin Capsules for Direct Consumption

| | I (wt. %) | II (wt. %) | III (wt. %) |
|---|---|---|---|
| Gelatin casing: | | | |
| Glycerol | 2.014 | 2.014 | 2.014 |
| Gelatin 240 Bloom | 7.91 | 7.91 | 7.91 |
| Sucralose | 0.065 | 0.065 | 0.065 |
| Allura red | 0.006 | 0.006 | 0.006 |
| Brilliant blue | 0.005 | 0.005 | 0.005 |
| Core composition: | | | |
| Vegetable oil triglycerides | 79.49 | 68.55 | 58.55 |
| (coconut oil fraction) | | | |
| Orange flavouring, containing | 10.0 | 20.0 | 28.65 |
| 2 wt. % compound 1, based on | | | |
| the total weight of the flavouring | | | |
| Neotame and aspartame | 0.01 | 0.05 | — |
| Sucralose | 0.10 | 0.15 | 0.40 |
| 2-Hydroxypropylmenthyl | 0.33 | 0.20 | — |
| carbonate | | | |
| 2-Hydroxyethylmenthyl | — | 0.20 | 1.00 |
| carbonate | | | |
| (1R,3R,4S)-menthyl-3- | — | 0.55 | 0.50 |
| carboxylic acid N-ethylamide | | | |
| (WS-3) | | | |
| (−)-menthoneglycerol acetal | — | 0.30 | 0.80 |
| (Frescolat MGA) | | | |
| Vanillin | 0.07 | — | 0.10 |

The gelatin capsules suitable for direct consumption were produced according to WO 2004/050069 and had a diameter of 5 mm; the weight ratio of core material to casing material was 90:10. The capsules opened in the mouth in less than 10 seconds and dissolved completely in less than 50 seconds.

### Further Embodiments

A first embodiment of the invention is the use
of a propenylphenyl glycoside of formula (I)

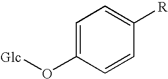

wherein
R is (1E)-prop-1-enyl, (1Z)-prop-1-enyl or prop-2-enyl and
Glc is an α- or β-glycosidically bonded mono- or oligo-saccharide, or
of a mixture comprising or consisting of two or more different propenylphenyl glycosides of formula (I) wherein R and Glc in each case have one of the meanings given above,
   for enhancing the sweet taste of a sweet-tasting substance or the sweet odour impression of a flavouring that produces a sweet odour impression.

A second embodiment is the use of the first embodiment wherein in formula (I) Glc is an α- or β-glycosidically bonded mono- or oligo-saccharide selected from the group consisting of D-glucopyranose, D-galactopyranose, D-mannopyranose, maltobiose, cellobiose, lactose, primeverose, neohesperidose and rutinose.

A third embodiment is the use according to one of the first two embodiments, wherein the or each propenylphenyl glycoside is selected from the group consisting of α- and β-anomers of
1-O-[4-(propen-2-enyl)phenyl]-D-glucopyranoside (chavicol glucoside compound 1),
1-O-[4-(propen-2-enyl)phenyl]-6-O-β-D-apiofuranosyl-D-glucopyranoside (furcatin, compound 2),
1-O-[4-(propen-2-enyl)phenyl]-6-O-β-D-rutinoside (compound 3) and
1-O-[4-(propen-2-enyl)phenyl]-O-β-D-xylopyranosyl-(1-6)-β-D-glucopyranoside (p-allylphenylprimeveroside, miyaginin, compound 4).

A fourth embodiment is the use according to any one of the preceding embodiments for enhancing the sweet taste of a sweet-tasting substance or the sweet odour impression of a flavouring that produces a sweet odour impression, in a preparation for nutrition, oral care or enjoyment.

A fifth embodiment is a preparation from the group consisting of preparations for nutrition, oral care or enjoyment, semi-finished products, fragrance, flavouring or taste-imparting compositions and spice mixtures, comprising the following components:
(a) one or more propenylphenyl glycosides of formula (I)

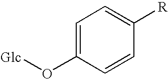

wherein in each case
R is (1E)-prop-1-enyl, (1Z)-prop-1-enyl or prop-2-enyl and
Glc is an α- or β-glycosidically bonded mono- or oligo-saccharide
   as well as
(b) one or more further sweet-tasting substances and/or
(c) one or more flavourings that produce a sweet odour impression,
   wherein the total amount of component (a) in the preparation is sufficient to enhance the sweet taste impression of the sweet-tasting substance(s) (b), or the sweet odour impression of the flavouring(s) (c) that produce a sweet odour impression, overproportionally in sensory terms.

A sixth embodiment is the preparation according to the fifth embodiment, wherein in formula (I) Glc is an α- or β-glycosidically bonded mono- or oligo-saccharide selected from the group consisting of D-glucopyranose, D-galactopyranose, D-mannopyranose, maltobiose, cellobiose, lactose, primeverose, neohesperidose and rutinose.

A seventh embodiment is the preparation according to the fifth or sixth embodiment, comprising as or in component (a):
a propenylphenyl glycoside selected from the group consisting of α- and β-anomers of
−1-O-[4-(propen-2-enyl)phenyl]-D-glucopyranoside (chavicol glucoside, compound 1),
1-O-[4-(propen-2-enyl)phenyl]-6-O-β-D-apiofuranosyl-D-glucopyranoside (turcatin, compound 2),
1-O-[4-(propen-2-enyl)phenyl]-6-O-β-D-rutinoside (compound 3) or
1-O-[4-(propen-2-enyl)phenyl]-O-β-D-xylopyranosyl-(1-6)-β-D-glucopyranoside (p-allylphenylprimeveroside, miyaginin, compound 4),
   or a mixture of two or more propenylphenyl glycosides from said group.

An eigth embodiment is a preparation according to any one of the fifth through seventh embodiments, comprising as or in component (b) one or more sugars, wherein the total amount of propenylphenyl glycosides of formula (I) (component (a)) in the preparation is sufficient to impart the same or an enhanced impression of sweetness as compared with a preparation which, while having an otherwise identical composition, does not comprise propenylphenyl glycosides of formula (I) but comprises at least 1.05 times the amount of sugar.

A ninth embodiment is a preparation according to any one of the fifth through eigth embodiments, comprising as or in component (b) one or more further sweet-tasting substances, the further sweet-tasting substance(s) being selected from the group consisting of:
(i) one or more carbohydrates selected from the group consisting of sucrose, trehalose, lactose, maltose, melizitose, melibiose, raffinose, palatinose, lactulose, D-fructose, D-glucose, D-galactose, L-rhamnose, D-sorbose, D-mannose, D-tagatose, D-arabinose, L-arabinose, D-ribose, D-glyceraldehyde, maltodextrin and plant preparations containing one or more of the mentioned carbohydrates,
(ii) one or more sugar alcohols selected from the group consisting of glycerol, erythritol, threitol, arabitol, ribitol, xylitol, sorbitol, mannitol, maltitol, isomaltitol, dulcitol and lactitol,
(iii) one or more proteins and/or amino acids from the group consisting of miraculin, monellin, thaumatin, curculin, brazzein, glycine, D-leucine, D-threonine, D-asparagine, D-phenylalanine, D-tryptophan, L-proline,
(iv) one or more sweeteners from the group consisting of magap, sodium cyclamate, acesulfame K, neohesperidin dihydrochalcone, saccharin sodium salt, aspartame, superaspartame, neotame, alitame, sucralose, stevioside, rebaudioside, lugduname, carrelame, sucrononate, sucrooctate, monatin and phyllodulcin,
   and mixtures thereof and/or
(c) one or more flavourings that produce a sweet odour impression, the further flavouring(s) that produce a sweet odour impression being selected from the group consisting of:
vanillin, ethylvanillin, ethylvanillin isobutyrate (=3-ethoxy-4-isobutyryloxybenzaldehyde), Furaneol® (2,5-dimethyl-4-hydroxy-3(2H)-furanone) and derivatives (e.g. homofuraneol, 2-ethyl-4-hydroxy-5-methyl-3(2H)-furanone), homofuronol (2-ethyl-5-methyl-4-hydroxy-3(2H)-furanone and 5-ethyl-2-methyl-4-hydroxy-3(2H)-furanone), maltol and derivatives (e.g. ethylmaltol), coumarin and derivatives, gamma-lactones (e.g. gamma-undecalactone, gamma-nonalactone), delta-lactones (e.g. 4-methyldeltalactone, massoilactone, deltadecalactone, tuberolactone), methyl sorbate, divanillin, 4-hydroxy-2(or 5)-ethyl-5(or 2)-methyl-3(2H)-furanone, 2-hydroxy-3-methyl-2-cyclopentenone, 3-hydroxy-4,5-dimethyl-2(5H)-furanone, fruit esters and fruit lactones (e.g. acetic acid n-butyl ester, acetic acid isoamyl ester, propionic acid ethyl ester, butyric acid ethyl ester, butyric acid n-butyl ester, butyric acid isoamyl ester, 3-methyl-butyric acid ethyl ester, n-hexanoic acid ethyl ester, n-hexanoic acid allyl ester, n-hexanoic acid n-butyl ester,
n-octanoic acid ethyl ester, ethyl-3-methyl-3-phenyl glycidate, ethyl-2-trans-4-cis-decadienoate), 4-(p-hydroxyphenyl)-2-butanone, 1,1-dimethoxy-2,2,5-trimethyl-4-hexane, 2,6-dimethyl-5-hepten-1-al and phenylacetaldehyde.

A tenth embodiment is a preparation for nutrition, oral care or enjoyment according to any one of the fifth through ninth embodiments, comprising a total amount of less than 0.05 wt. % (500 ppm), preferably less than 0.025 wt. % (250 ppm), of propenylphenyl glycosides of formula (I), based on the total weight of the preparation.

An eleventh embodiment is a preparation for nutrition, oral care or enjoyment according to any one of the fifth through tenth embodiments, comprising a total amount in the range from 0.1 to 500 ppm, preferably in the range from 1 to 250 ppm, particularly preferably in the range from 50 to 200 ppm, of propenylphenyl glycosides of formula (I), based on the total weight of the preparation.

A twelfth embodiment is a preparation for nutrition, oral care or enjoyment according to any one of the fifth through eleventh embodiments, wherein the preparation is selected from the group consisting of:
(A) confectionery,
(B) alcoholic or non-alcoholic drinks or instant drinks,
(C) cereal products and/or nut products,
(D) milk products,
(E) fruit and/or vegetable preparations,
(F) products based on fats and oils or emulsions thereof,
(G) oral care products.

A thirteenth embodiment is a preparation for nutrition, oral care or enjoyment according to any one of the fifth through twelf embodiments, comprising
component (a), comprising or consisting of propenylphenyl glycosides,
component (b), comprising or consisting of one or more sugars
   as well as optionally
component (c),
wherein the total amount of component (a) in the preparation
   is sufficient to impart the same or an enhanced sweetness impression as compared with a preparation which, while having an otherwise identical composition, does not comprise propenylphenyl glycosides of formula (I) but comprises at least 1.05 times the amount of sugar and/or
   is in the range from 0.1 to 500 ppm.

A fourteenth embodiment is a preparation according to any one of the fifth through ninth embodiments, selected from the group consisting of semi-finished products, fragrance, flavouring or taste-imparting compositions and spice mixtures, comprising a total amount in the range from 0.0001 wt. % to 95 wt. %, preferably from 0.001 wt. % to 80 wt. %, particularly preferably from 0.001 wt. % to 50 wt. %, of propenylphenyl glycosides of formula (I), based on the total weight of the preparation.

A fifteenth embodiment is a semi-finished product according to any one of the fifth through ninth embodiment or the fourteenth embodiment, characterised in that it has been spray-dried.

A sixteenth embodiment is a preparation according to any one of the fifth through fifteenth embodiments, comprising
as additional component (d)
one or more esters selected from the group consisting of lactic acid C₁-C₆-esters, tartaric acid C₁-C₄-esters, succinic acid di-C₁-C₄-esters, malonic acid di-C₁-C₄-esters, malic acid di-C₁-C₄-esters, citric acid di-C₁-C₄-esters and citric acid tri-C₁-C₄-esters and/or
one or more solvents selected from the group consisting of 1,2-propylene glycol, dimethyl sulfoxide, ethanol and ethanol/water mixtures.

A seventeenth embodiment is a preparation according to any one of the fifth through sixteenth embodiments, further comprising at least one further substance for masking or reducing a bitter, metallic, chalky, acidic or astringent taste impression or for enhancing a sweet, salty or umami taste impression.

An eighteenth embodiment is a preparation according to any one of the fifth through seventeenth embodiments, comprising one or more substances from the group consisting of hesperetin, phloretin and salts thereof.

A nineteenth emboodiment is a method for enhancing the sweet taste of a sweet-tasting substance or the sweet odour impression of a flavouring that produces a sweet odour impression, comprising the following step:
one or more sweet-tasting substances (component (b)) or one or more flavourings that produce a sweet odour impression (component (c)) is/are mixed with a total amount of a component (a) as defined in any one of the fifth through seventh embodiments,
   wherein the total amount of component (a) in the preparation is sufficient sensorially to enhance the sweet taste impression of the sweet-tasting substance(s) (b) or the sweet odour impression of the flavouring(s) (c) that produce a sweet odour impression.

A twentieth embodiment is a propenylphenyl glycoside of formula (I)

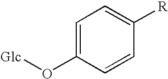

wherein
R is (1E)-prop-1-enyl, (1Z)-prop-1-enyl or prop-2-enyl and
Glc is an α-glycosidically bonded mono- or oligo-saccharide, or
   a mixture comprising or consisting of two or more different propenylphenyl glycosides of formula (I) wherein R and Glc in each case have one of the meanings given above.

1. A method for enhancing the sweet taste of a sweet-tasting substance or the sweet odour impression of a flavoring that produces a sweet odour impression, comprising adding a compound comprising one or more propenylphenyl glycosides of formula (I) 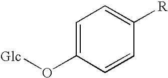
wherein
R is (1E)-prop-1- enyl, (1Z)-prop-1-enyl or prop-2-enyl, and
Glc is an α- or βglycosidically bonded mono- or oligo-saccharide;
to a sweet-tasting substance or a flavoring.

2. The method of claim 1 wherein in formula (I)
Glc is an α- or βglycosidically bonded mono- or oligo-saccharide selected from the group consisting of D-glucopyranose, D-galactopyranose, D-mannopyranose, maltobiose, cellobiose, lactose, primeverose, neohesperidose, and rutinose.

3. The method of claim 1, wherein the propylphenyl glycoside of formula (I) is selected from the group consisting of α- and β-anomers of 1-O-[4-(propen-2-enyl)phenyl]-D-glucopyranoside (chavicol glucoside, compound 1), 1-O-[4-(propen-2-enyl)phenyl -6O-β-D-apiofuranosyl-D-glucopyranoside (furcatin, compound 2), 1-O-[4-propen-2enyl)phenyl]-6-O-β-D-rutinoside (compound 3), and 1-O-[4-(propen-2-enyl)phenyl -O-β-D-xylopyranosyl-(-1-6)-β-D-glycopyranoside (p-allylphenylprimeveroside, miyaginin, compound 4).

4. The method of claim 1, further comprising adding said sweet tasting substance or flavoring to a preparation used for nourishment, oral hygiene, or consumption.

5. A preparation for nutrition, oral care, enjoyment, semi-finished products, fragrance, flavoring, taste-imparting compositions, spice mixtures, comprising:
(a) one or more propenylphenyl glycosides of formula (I) 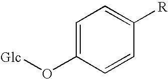
wherein
R is (1E)-prop-1-enyl, (1Z)-prop-1-enyl or prop-2-enyl; and
Glc is an α- or β-glycosidically bonded mono- or oligo-saccharide; and
a second compound selected from the group consisting of
(b) one or more further sweet-tasting substances;
(c) one or more flavourings that produces a sweet odor impression; and mixtures thereof;
wherein the total amount of (a) in the preparation is sufficient to enhance the sweet taste impression of the sweet-tasting substances (b), or the sweet odor impression of the flavorings (c) that produce a sweet odor impression.

6. The preparation of claim 5, wherein in formula (I)
Glc is an α- or β-glycosidically bonded mono- or oligo-saccharide selected from the group consisting of D-glucopyranose, D-galactopyranose, D-mannopyranose, maltobiose, cellobiose, lactose, primeverose, neohesperidose, and rutinose.

7. The preparation of claim 5, wherein (a) is a propenylphenyl glycoside selected from the group consisting of α- and β-anomers of 1-O-[4-(propen-2-enyl)phenyl]-D-glucopyranoside (chavicol glucoside, compound 1); 1-O-[4-(propen-2-enyl)phenyl]-6-O-β- D-apiofuranosyl-D-glucopyranoside (furcatin, compound 2); 1-O-[4-(propen-2-enyl)phenyl]-6-O-β-D-rutinose (compound 3); 1-O-[4-(propenyl-2-enyl)phenyl]-Oβ-D-xylopyranosyl-(1-6)-β-D-glucopyranoside (p-allylphenylprimeveroside, miyaginin, compound 4); and mixtures thereof.

8. The preparation of claim 5, wherein (b) comprises one or more sugars, and the total amount of (a) in the preparation is sufficient to impart the same or an enhanced impression of sweetness as compared with a preparation which, while having an otherwise identical composition, does not comprise propenylphenyl glycosides of formula (I) but comprise at least 1.05 times the amount of sugar.

9. The preparation of claim 5, wherein (b) is selected from the group consisting of:
(i) one or more carbohydrates selected from the group consisting of sucrose, trehalose, lactose, maltose, melizitose, melibiose, raffinose, palatinose, lactulose, D-fructose, D-glucose, D-galactose, L-rhamnose, D-sorbose, D-mannose D-tagatose, D-arabinose, L-arabinose, D-ribose, D-glyceraldehyde, maltodextrin and plant preparations containing one or more of the mentioned carbohydrates,
(ii) one or more sugar alcohols selected from the group consisting of glycerol, erythritol, threitol, arabitol, ribitol, xylitol, sorbitol, mannitol, maltitol, isomaltitol, dulcitol and lactitol,
(iii) one or more proteins and/or amino acids from the group consisting of miraculin, monellin, thaumatin, curculin, brazzein, glycine, D-leucine, D-threonine, D-asparagine, D-phenylalanine, D-tryptophan, L-proline,
(iv) one or more sweeteners from the group consisting of magap, sodium cyclamate, acesulfame K, neohesperidin dihydrochalcone, saccharin sodium salt, aspartame, superaspartame, neotame, alitame, sucralose, stevioside, rebaudioside, lugduname, carrelame, sucrononate, sucrooctate, monatin, mogrosides and phyllodulcin; and
(v) mixtures thereof; and
(c) is selected from the group consisting of:
vanillin, ethylvanillin, ethylvanillin isobutyrate (=3-ethoxy-4-isobutyryloxybenzaldehyde), Furaneol® (2,5-dimethyl-4-hydroxy-3(2H)-furanone and derivatives, (e.g. homofuraneol, 2-ethyl-4-hydroxy-5-methyl-3(2H)-furanone), homofuronol (2-ethyl-5-methyl-4-hydroxy-3(2H)-furanone and 5-ethyl-2-methyl-4-hydroxy-3(2H)-furanone), maltol and derivatives (e.g. ethylmaltol), coumarin and derivatives, gamma-lactones (e.g. gamma-undecalactone, gamma-nonalactone), delta-lactones (e.g. 4-methyldeltalactone, massoilactone, deltadecalactone, tuberolactone), methyl sorbate, divanillin, 4hydroxy-2(or 5)-ethyl-5(or 2)-methyl-3(2H)-furanone, 2-hydroxy-3-methyl-2-cyclopentenone, 3-hydroxy-4,5-dimethyl-2(5H) furanone, fruit esters and fruit lactones (e.g. acetic acid n-butyl ester, acetic acid isoamyl ester, propionic acid ethyl ester, butyric acid ethyl ester, butyric acid n-butyl ester, butyric acid isoamyl ester, 3-methyl-butyric acid ethyl ester, n-hexanoic acid ethyl ester, n-hexanoic acid allyl ester, n-hexanoic acid n-butyl ester, n-octanoic acid ethyl ester, ethyl-3-methyl-3-phenyl glycidate ethyl-2-trans-4-cis-decadienoate), 4-(p-hydroxyphenyl)-2-butanone, 1,1-dimethoxy-2,2,5-trimethyl-4-hexane, 2,6-dimethyl-5-hepten-1-al, and phenylacetaldehyde.

10. The preparation of claim 5, wherein the total amount of propenylphenyl glycosides of formula (I) is less than 0.05 wt.% (500 ppm) based on the total weight of the preparation.

11. The preparation of claim 5, wherein the total amount of propenylphenyl glucosides of formula (I) is in the range from 0.1 to 500 ppm based on the total weight of the preparation.

12. The preparation of claim 5, wherein the preparation is selected from the group consisting of:
(A) confectionery;
(B) alcoholic or non-alcoholic drinks or instant drinks;
(C) cereal products and/or nut products;
(D) milk products;
(E) fruit and/or vegetable preparations;
(F) products based on fats and oils or emulsions thereof; and
(G) oral care products.

13. The preparation of claim 5, wherein (b) comprises one or more sugars, and the total amount of (a) in the preparation
is sufficient to impart the same or an enhanced sweetness impression as compared with a preparation which, while having an otherwise identical composition, does not comprise propenylphenyl glycosides of formula (I) but comprises at least 1.05 times the amount of sugar; and
is in the range from 0.1 to 500 ppm.

14. The preparation of claim 5, wherein the preparation is selected from the group consisting of semi-finished products, fragrance, flavoring or taste-imparting compositions and spice mixtures, and the total amount of the propenylphenyl glycosides of formula (I) is in the range from 0.0001 wt.% to 95 wt. based on the total weight of the preparation.

15. The preparation of claim 5. wherein the preparation has been spray-dried.

16. The preparation of claim 5, further comprising as (d):
one or more esters selected from the group consisting of lactic acid C₁-C₆-esters, tartaric acid C₁-C₄-esters, succinic acid di-C₁-C₄-esters, malonic acid di-C₁-C₄-esters, malic acid di-C₁-C₄-esters, citric acid di-C₁-C₄-esters and citric acid tri-C₁-C₄-esters; and optionally
one or more solvents selected from the group consisting of 1,2-propylene glycol, dimethyl sulfoxide, ethanol/water mixtures.

17. The preparation of claim 5, further comprising at least one substance for masking or reducing a bitter, metallic, chalky, acidic, or astringent taste impression or for enhancing a sweet, salty, or umami taste impression.

18. The preparation of claim 5, further comprising one or more substances from the group consisting of hesperetin, phloretin, and salts thereof.

19. A compound comprising one or more propenylphenyl glycosides of formula (I) 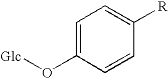
wherein
R is (1E)-prop-1-enyl, (1Z)-prop-1-enyl or prop-2-enyl; and
Glc is an α-glycosidically bonded mono- or oligo-saccharide.
